(19) United States
(12) Patent Application Publication
(10) Pub. No.: US 2016/0255535 A1
(43) Pub. Date: Sep. 1, 2016

(54) ENABLING INFORMATION CENTRIC NETWORKS SPECIALIZATION

(71) Applicant: INTERDIGITAL PATENT HOLDINGS, INC., Wilmington, DE (US)

(72) Inventors: Xavier De Foy, Kirkland (CA); Bartosz Balazinski, Montreal (CA); Alexander Reznik, Pennington, NJ (US); Juan Carlos Zuniga, Ville St. Laurent, Montreal (CA); Jun Li, Cranbury, NJ (US); John Cartmell, North Massapequa, NY (US); Hang Liu, North Potomac, MD (US)

(73) Assignee: InterDigital Patent Holdings, Inc., Wilmington, DE (US)

(21) Appl. No.: 15/033,366

(22) PCT Filed: Oct. 30, 2014
(86) PCT No.: PCT/US2014/063132

§ 371 Date: Apr. 29, 2016

Related U.S. Application Data
(60) Provisional application No. 61/897,785, filed on Oct. 30, 2013.

(51) Int. Cl. H04W 28/02; H04L 12/725; H04L 29/08

(52) U.S. Cl. CPC H04W 28/0247; H04L 67/1014; H04W 28/0268; H04W 28/0257; H04L 45/302; H04L 67/2847

(57) ABSTRACT

Systems, methods, and instrumentalities are disclosed for defining a network specialization mechanism that enables a better alignment between end users' usage profiles and their access networks. Conteni specialization of networks may be implemented as a preference o a particular SCN or network in terms of content. Such a network may, for example, cache in priority preferred content, provide preferential quality of service (QoS), or limit access to non-preferred content. A network may advertise its preference or content specialization to end users (e.g., so that end users can decide to attach to SCNs or networks with compatible preferences) and to other content networks (e.g., to influence content routing decisions or to negotiate partitioning of the specialization space). Such content specialization may apply to physical or virtual networks.

### CROSS-REFERENCE TO RELATED APPLICATIONS

This application claims the benefit of U.S. Provisional Patent Application No. 61/897,785, filed Oct. 30, 2013, the content of which is hereby incorporated by reference herein.

### BACKGROUND

Small Cell Networks (SCN) may suffer from a bottleneck at the backhaul level. A SCN may cache data objects requested by a user to increase efficiency (such as, if the data objects are requested by another user). Even if storage capacity is cheap and large caches can be deployed in SCNs, edge caching serving a limited population (e.g., tens or hundreds of users) may get a low cache hit ratio.

To improve network efficiency, methods are needed to increase a cache hit ratio, or otherwise pair cached content with users that may request such content.

### SUMMARY

Systems, methods, and instrumentalities are disclosed for network specialization that may enable a better alignment between end users' usage profiles and access networks. Content specialization of networks may be implemented, e.g., as a preference of a particular SCN or network in terms of content. Such a network may, for example, prioritize the caching of preferred content, provide preferential quality of service (QoS), or limit access to non-preferred content.

A network may advertise its preference or content specialization to end users (e.g., so that end users can decide to attach to SCNs or networks with compatible preferences) and to other content networks (e.g., to influence content routing decisions or to negotiate partitioning of the specialization space). Such content specialization may apply to physical or virtual networks.

Content metadata may be rated in relation to the content specialization of a network or networks, or domains within a network, to influence decisions relating to routing of content requests. For example, a wireless transmit/receive unit (WTRU) may retrieve content in a network by generating a user profile as a function of metadata collected for a plurality of content objects. The WTRU may rate the user profile in relation to respective network specializations of a plurality of networks. The WTRU may attach to a network of the plurality of networks having a network specialization in relation to which the user profile has a highest rating.

A network may prioritize the caching of preferred content. For example, a network may cache content by receiving metadata relating to the content and rating the metadata in relation to a network specialization of the network. A caching decision regarding the content may be made based on the rating of the metadata. For example, the network may determine that the content relates to the specialization of the network. In such a case, the network may determine to cache the content.

A network may provide preferential QoS to preferred content. For instance, to deliver a content object, a network may first receive this content object and metadata relating to the content object. A rating may be determined based on the metadata. The content object may be sent with a level of service determined based on the rating. For example, the content object may be sent using a dedicated bearer if the rating is greater than a threshold. The content object may be sent using a default bearer if the rating is not greater than the threshold.

### BRIEF DESCRIPTION OF THE DRAWINGS

FIG. 1A is a system diagram of an example communications system in which one or more disclosed embodiments may be implemented.

FIG. 1B is a system diagram of an example wireless transmit/receive unit (WTRU) that may be used within the communications system illustrated in FIG. 1A.

FIG. 1C is a system diagram of an example radio access network and an example core network that may be used within the communications system illustrated in FIG. 1A.

FIG. 1D is a system diagram of another example radio access network and another example core network that may be used within the communications system illustrated in FIG. 1A.

FIG. 1E is a system diagram of another example radio access network and another example core network that may be used within the communications system illustrated in FIG. 1A.

FIG. 2 is a diagram illustrating an example Bloom Filter.

FIG. 3 is a table illustrating an example mapping between specialized controlled vocabularies and the Dewey Decimal Classification (DDC) system.

FIG. 4 is a diagram illustrating, by way of an overview, some of the ways in which content specialization may be used in a network.

FIG. 5 is a diagram illustrating an example summary representation.

FIG. 6 is a diagram illustrating an example network that may incorporate network functions and interfaces to enable metadata-based specialization.

FIG. 7 is a diagram illustrating an example content centric network (CCN) in which content specialization may be implemented.

FIG. 8 is a diagram illustrating an example Publish Subscribe Internet Routing Paradigm (PSIRP) network in which content specialization may be implemented.

FIG. 9 is a diagram illustrating an example access IP network deploying an HTTP proxy cache.

FIG. 10 is a diagram illustrating an example message flow for differentiated caching in a cellular network.

FIG. 11 is a diagram illustrating an example message flow for differentiated caching in a cellular network.

FIG. 12 is a diagram illustrating an example message flow for differentiated caching in a cellular network.

FIG. 13 is a diagram illustrating an example message flow for differentiated quality of service in a cellular network.

FIG. 14 is a diagram illustrating an example message flow for a metadata lookup service.

FIG. 15 is a diagram illustrating an example Least Recently Used content replacement policy.

FIG. 16 is a diagram illustrating an example Least Frequently Used (LFU) content replacement policy.

FIG. 17 illustrates an example System Information Block (SIB) format that may include network specialization information.

FIG. 18 is a diagram illustrating an example message flow for using network specialization advertisements by cellular networks by WTRUs to determine which network to attach to.

FIG. 19 illustrates an example ANQP network specialization information element.

FIG. 20 is a diagram illustrating an example message flow for using network specialization advertisements by a WiFi network by WTRUs to determine which network to attach to.

FIG. 21 illustrates an example of user profile generation on a WTRU and selection of an access network based on network specialization.

FIG. 22 illustrates an example message structure for inter-domain network specialization communication.

FIG. 23 is a diagram illustrating an example of network specialization awareness.

FIG. 24 illustrates an example message flow that may be used in CDN specialization.

FIG. 25 illustrates an example message flow for cooperative support for dynamic metadata-based roaming.

FIG. 26 illustrates an example message flow for a network specialization service.

FIG. 27 illustrates an example message flow for routing content requests through different virtual networks.

FIG. 28 illustrates an example message flow for a metadata rating service.

### DETAILED DESCRIPTION

A detailed description of illustrative embodiments will now be described with reference to the various Figures. Although this description provides a detailed example of possible implementations, it should be noted that the details are intended to be exemplary and in no way limit the scope of the application.

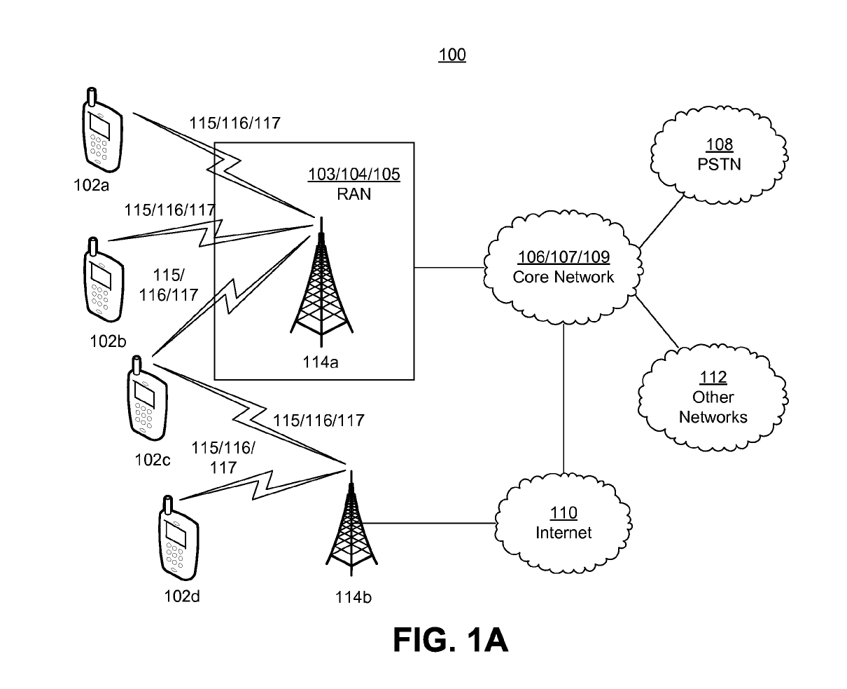

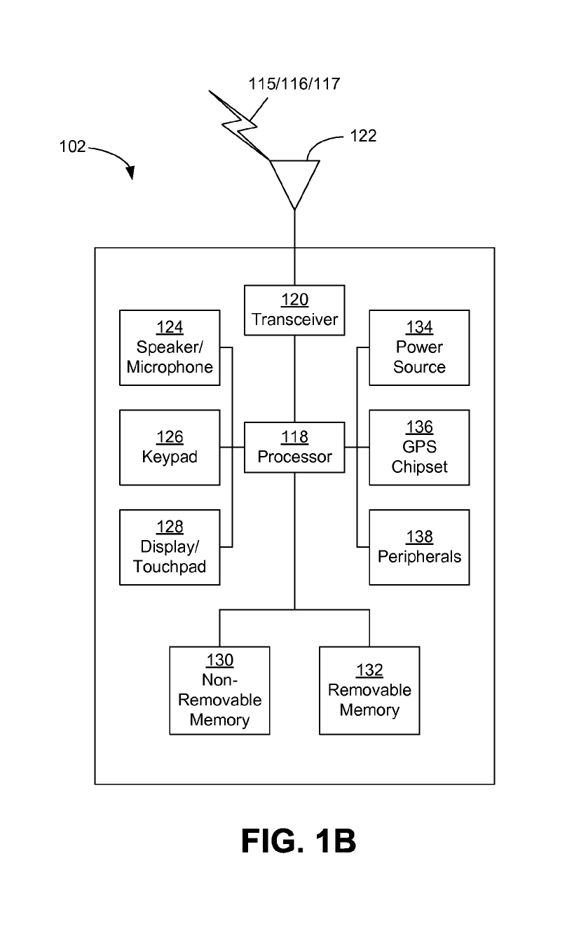

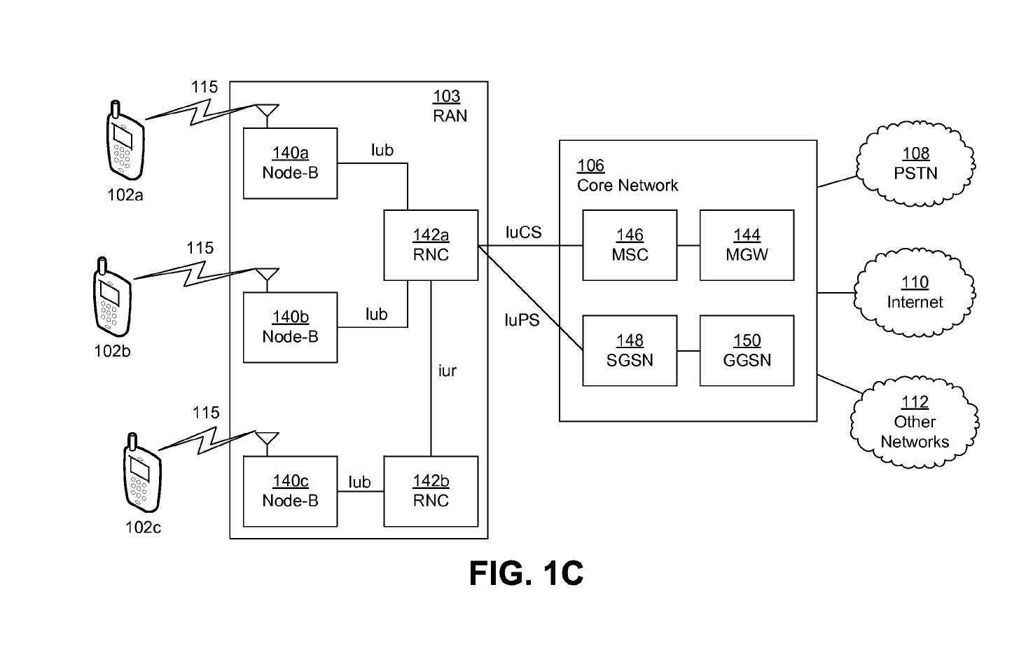

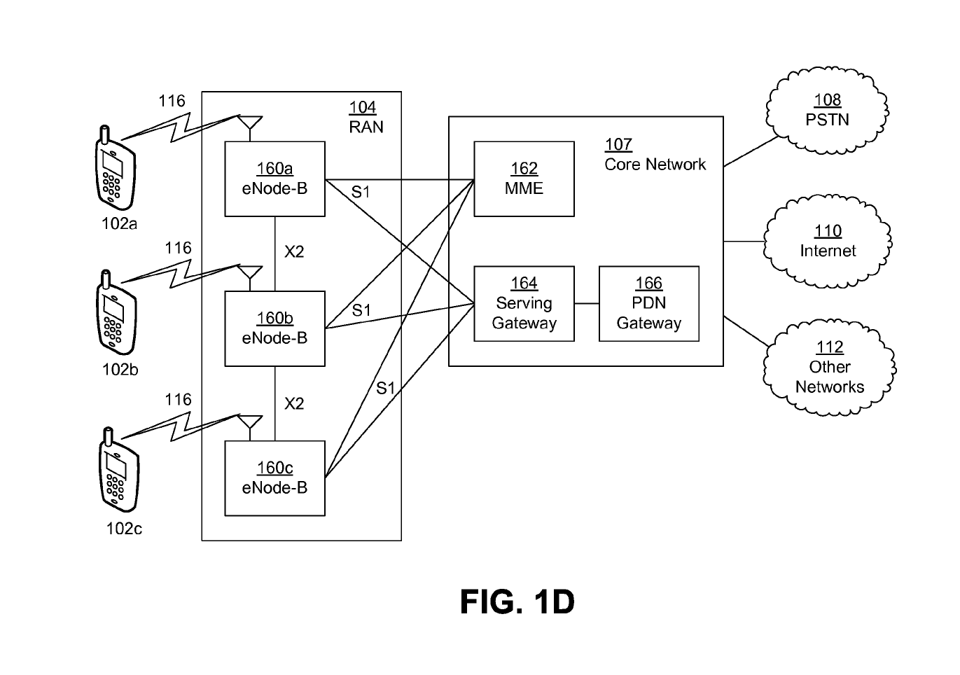

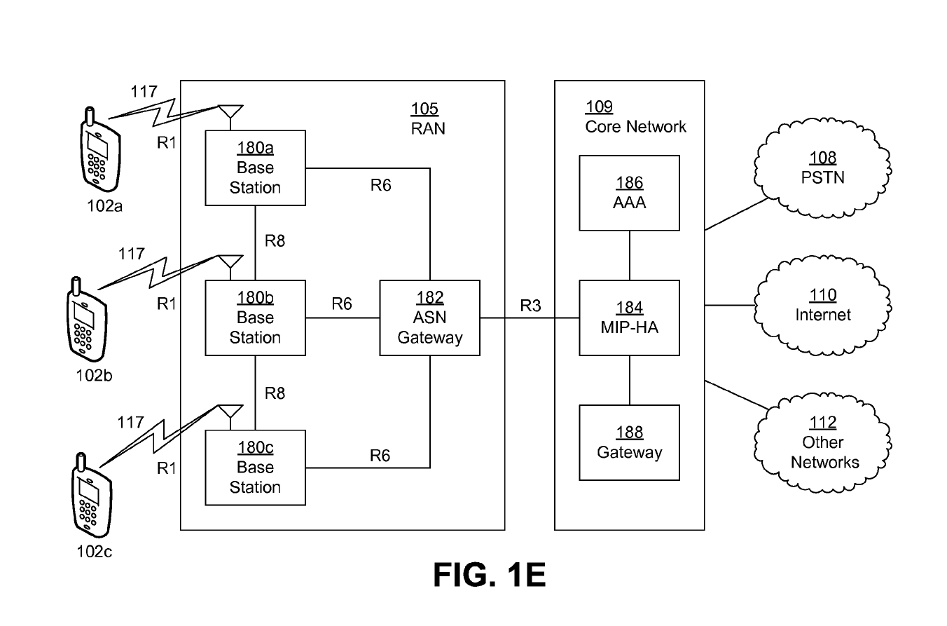

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications system 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, and/or 102d (which generally or collectively may be referred to as WTRU 102), a radio access network (RAN) 103/104/105, a core network 106/107/109, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications system 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106/107/109, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, e.g., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 115/116/117, which may be any suitable wireless communication link (e.g., radio frequency (RF), microwave, infrared (IR), ultraviolet (UV), visible light, etc.). The air interface 115/116/117 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA).

WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 115/116/117 using Long Term Evolution (LTE) and/or LTE-Advanced (LTE-A).

In other embodiments, the base station 114a and the WTRUs 102a, 102b, 102c may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106/107/109.

The RAN 103/104/105 may be in communication with the core network 106/107/109, which may be any type of network configured to provide voice, data, applications, and/or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication. Although not shown in FIG. 1A, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 or a different RAT.

Some or all of the WTRUs 102a, 102b, 102c, 102d in the communications system 100 may include multi-mode capabilities, e.g., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB or HeNodeB), a home evolved node-B gateway, and proxy nodes, among others, may include some or all of the elements depicted in FIG. 1B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination implementation while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 103 and the core network 106 according to an embodiment. As noted above, the RAN 103 may employ a UTRA radio technology to communicate with the WTRUs 102a, 102b, 102c over the air interface 115. The RAN 103 may also be in communication with the core network 106. As shown in FIG. 1C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an embodiment.

As shown in FIG. 1C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 1D is a system diagram of the RAN 104 and the core network 107 according to an embodiment. As noted above, the RAN 104 may employ an E-UTRA radio technology to communicate with the WTRUs 102a, 102b, 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink and/or downlink, and the like. As shown in FIG. 1D, the eNode-Bs 160a, 160b, 160c may communicate with one another over an X2 interface.

The core network 107 shown in FIG. 1D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 1E is a system diagram of the RAN 105 and the core network 109 according to an embodiment. The RAN 105 may be an access service network (ASN) that employs IEEE 802.16 radio technology to communicate with the WTRUs 102a, 102b, 102c over the air interface 117. As will be further discussed below, the communication links between the different functional entities of the WTRUs 102a, 102b, 102c, the RAN 105, and the core network 109 may be defined as reference points.

As shown in FIG. 1E, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, 180c may each be associated with a particular cell (not shown) in the RAN 105 and may each include one or more transceivers for communicating with the WTRUs 102a, 102b, 102c over the air interface 117. In one embodiment, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 1E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 1E, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

Network specialization may be implemented. Because there can be many networks, including SCNs, with overlapping footprints in an area, if data objects can be spread in caches across these networks instead of being duplicated, then the edge caching capacity and cache hit ratio may be increased. Specialization may relate to caching specialization, but it can be extended to other aspects as well. A network may provide preferential quality of service (QoS) to certain content. A network may provide access only to such content. A network may require that a wireless transmit/receive unit (WTRU) mostly consume a certain type or types of content.

Caching load may be distributed between caches by using a hashing algorithm on data object names or other metadata. Based on the result of this hashing algorithm, the data object may be cached on one of the distributed caches. This may be adapted in information centric networking (ICN) as hash-routing schemes. Hash-routing schemes may not be applicable to distribute data objects across different networks (e.g., including SCNs). If a user requests two data objects, it may be likely that the hashing value calculated for these objects will lead to them going to different buckets, e.g., in this case, to different networks, while it may not be realistic to require the WTRU to reattach to a new network every time it requests a new content object. Hashing may not be an effective way to specialize distinct networks.

Bloom Filters (BF) may be probabilistic data structures that may apply to a variety of applications. A Bloom Filter may be an array of m bits, and representing n elements. An element may be added in a Bloom Filter by applying k hash functions on the desired property (e.g., a piece of information, such as content name, or the whole content object, or a property of an object, etc.), where the output of the hash functions may be an integer in the range of 0 to (m−1), inclusive. The hash functions may be fixed for a given BF. The k bits corresponding to the k hash function results may be set to 1. To query for the presence of a particular object, the same k functions may be applied on the same property of the object, and the corresponding bits of the BF may be tested. If the bits are all set to 1 there is a high probability that this object is represented in the BF.

In this example BF, objects may not be removable, and there is a chance of false positive (e.g., an object not added in the BF but with all k hash functions results pointing to 1 bits in the BF). Some Bloom Filters may support, for example, counting, removal, long term stability, trading off false negatives for other properties, etc. Bloom Filters may have many applications in distributed computing, including, for example, summarizing content (e.g., between caches or in P2P networks), distributed storage (e.g., Google's Bigtable), routing/forwarding (IP lookups, loop detection, etc.), network monitoring, security, etc.

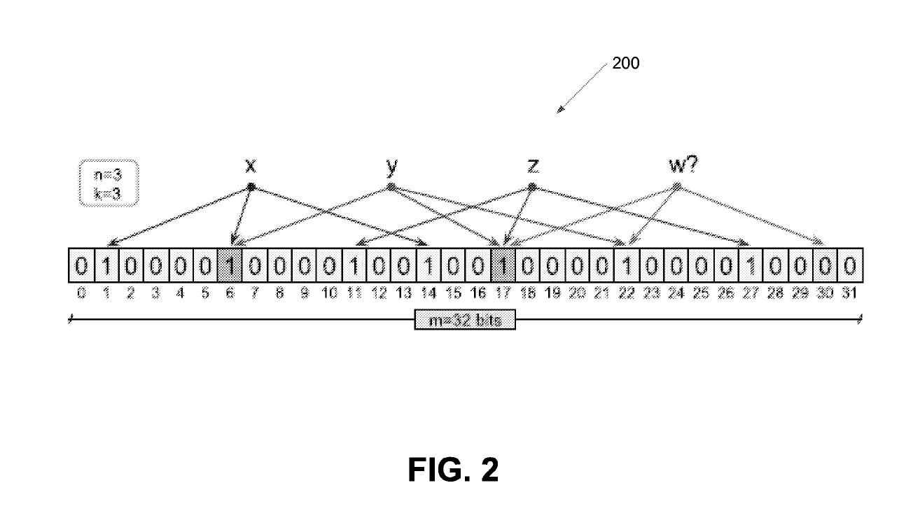

FIG. 2 illustrates an example Bloom Filter 200 with m=32 bits, n=3 elements x, y, and z, and k=3 hash functions. Element w may be tested for inclusion and may be correctly found not included in the BF.

Metadata may be characterized as data about data. Metadata may provide information about one or more aspects of the data, which may include, for example: means, time and data of creation; creator or author; standards used; purpose, title, summary, keywords, classification, etc. Metadata may be descriptive and may facilitate resource discovery and identification. Metadata may be administrative and may support resource management within a collection. Metadata may be structural and may bind together the components of complex information objects.

One metadata standard, known as the Dublin Core Metadata Initiative (DCMI), may be used to describe web resources (e.g., video, images, web pages, etc.), physical resources such as books, and objects like artworks. DCMI defines properties such as title, type, description, creator, publisher, etc. The value for the ‘type’ property may use a controlled vocabulary, such as a general vocabulary or a specialized vocabulary.

An example of a general vocabulary is the Dewey Decimal Classification (DDC) system used in libraries. In the DDC system, for example, the code 500 may refer to natural sciences and mathematics, the code 510 may refer to mathematics, and the code 516 may refer to geometry. The code 516.3 may refer to analytic geometries, the code 516.37 may refer to metric differential geometries, and the code 516.375 may refer to Finsler Geometry. Other examples of general vocabularies may include the Library of Congress Subject Headings (LCSH), a DCMI Type Vocabulary, and the UNESCO Thesaurus, which covers education, science, culture, social and human sciences, information and communication, and politics, law and economics.

An example of a specialized vocabulary may be Medical Subject Headings (MeSH). Another example of a specialized vocabulary may be an Art and Architecture Thesaurus (AAT).

To put controlled vocabularies into context, indexing of content can use unstructured, uncontrolled keyword indexes. Indexing of content may use unstructured, controlled indexing languages (e.g., headers in the Yellow Pages). Indexing of content may use structured, controlled thesauri, which may list words grouped together, for example, according to similarity of meaning. Classification systems, such as the Library of Congress Subject Headings or the Dewey Decimal Classification system, may be structured, controlled, and coded.

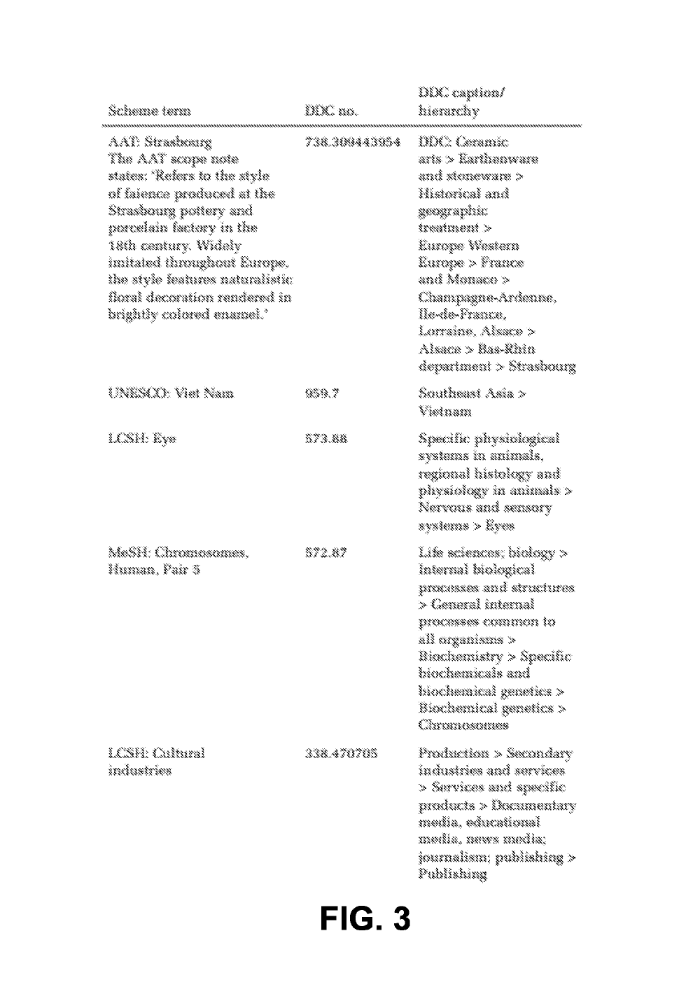

FIG. 3 is a table illustrating an example mapping between specialized controlled vocabularies and the Dewey Decimal Classification (DDC) system. In FIG. 3, DDC classification is illustrated using numerical code and its equivalent in text.

Content specialization of networks may be implemented as a preference of a particular SCN or network in terms of content. Such a network may, for example, cache in priority preferred content, provide preferential quality of service (QoS), or limit access to non-preferred content. A network may advertise its preference or content specialization to end users (e.g., so that end users can decide to attach to SCNs or networks with compatible preferences) and to other content networks (e.g., to influence content routing decisions or to negotiate partitioning of the specialization space). Such content specialization may apply to physical or virtual networks.

Network content specialization may be based on metadata associated with a data object, including, for example, classification metadata, content name, ID, publisher, origin, owner, etc. Any form of descriptive metadata may be used to form a basis for network content specialization. Controlled vocabularies, such as the Dewey Decimal Classification system, or any other general purpose or specialized vocabularies, may be relevant. For example, general document subject/type metadata may use Dewey Decimal Classification (DDC), Library of Congress Subject Headings (LCSH), etc. Specialized domain document subject/type metadata may use Medical Subject Headings (MeSH), National Library of Medicine Classification (NLM), etc. Language metadata may use tags, for example, defined by RFC4646 to identify languages. Document encoding metadata may use MIME media types, for example, defined by IANA.

Content License metadata may use vocabularies derived from existing Rights Expression Languages (RELs), for example, including a set of URLs. Each URL may represent one particular license. RELs may describe licenses in term or rights, constraints, or actors. One or more applicable license names may be attributed to an object, where a license name refers to a full description of a license (e.g., CC-BY). Publisher name metadata may use a vocabulary formed of a set of domain names, representing major publishers (e.g., nbc.com, disney.com, universalsudios.com, etc.).

Open vocabularies may be used. For example, the Twitter service allows users to define hashtags. Other examples may include keywords included by content authors in certain documents and keywords extracted from content by automated tools such as crawlers. Network content specialization may not be able to cover the whole set of possible tags. Content rating may become more complicated, in the sense that the rating function may not be able to limit itself to check for exact matches, but may instead determine equivalence between tags in the content specialization and in the content metadata.

Within an information centric network, or within an IP network for content transported over HTTP, some or all data objects can be associated with such metadata. This association may be a list of tags along with the vocabulary they relate to, in plain text, coded binary or in summary (e.g., Bloom Filter) form. This metadata information or a reference to the metadata information can be transported along with the content object or can be obtained from a lookup service. Video/audio content can be related to metadata information. For example, keywords found by search engines' crawlers in web pages may link to such content, e.g., MPEG-21 digital item identification and description. As another example, an ID3 metadata container may be used to carry title and composer with MP3 audio files.

The network may use this metadata information, for example, to align (e.g., optimize) network resource usages and user experience. Network content specialization may be expressed as the concatenation of tags (e.g., all tags) that the network operator may be interested in (e.g., for caching, QoS, etc.), which may be in a summarized form. A network element may have knowledge of the network preference and the content object metadata information and may be able to calculate a rating for the content object in regard to the network preference and use this rating to guide its decisions. Examples of network preference-related actions may include one or more of the following: giving preferential caching/QoS treatment to preferred content, advertising network preference to WTRUs to guide a WTRU's network access selection, providing content or network recommendations to WTRUs, communicating with other networks to guide routing decisions, cooperating with other networks to improve (e.g., optimize) network specialization, or redirecting WTRUs to other networks, e.g., more appropriate networks.

For example, consumers of sports-related content may be invited to attach to a first network (e.g., a Small Cell Network), consumers of movies may be invited to attach to a second network that overlaps the first network, etc. The first network may primarily cache sports-related content, and the second network may primarily cache movie-related content. If a user of the first network wishes to access movie-related content, he or she may be redirected to attach through the second network, or the first network may obtain the desired content from the second network. As illustrated in this example, content specialization may limit the amount of content duplicated in caches and on the wire, between the first and second networks. The distribution of cached content may be focused to fit the need of a set of users, and on the other side, users can be directed to use networks that match their profile. This network configuration may align user interest with network specialization. Network operators may be able to serve more users for given transit costs since there may be a higher cache hit ratio. End users may experience increased quality of service through better cache hit ratio. End users may be able to expect optimum quality of service for certain types of content depending on the context (e.g., in university campuses for studied subject matters, in museums for art-related content, or in stadiums for sport-related content, etc.)

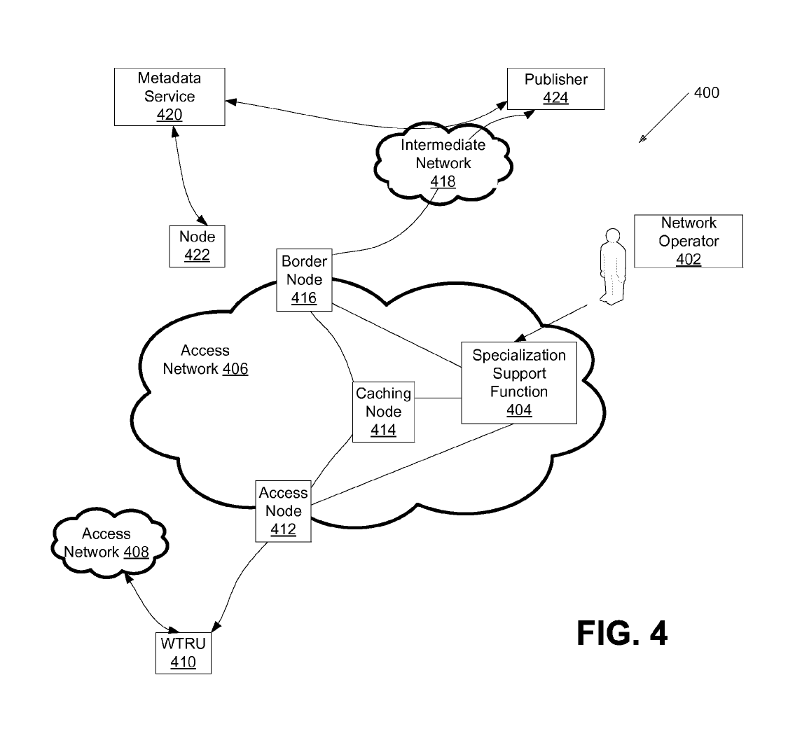

FIG. 4 illustrates, by way of an overview, exemplary ways in which content specialization may be used in a network 400. A network operator 402 may set and refine content specialization. A specialization support function 404 may configure content specialization and may collect information or statistics from one or more networks to help refine content specialization over time. Access networks 406, 408 may advertise their content specialization to a WTRU 410 to help in network selection. The WTRU 410 may send certain content requests or responses through an access network 406, 408 (e.g., access network 408) with a different content specialization that better fits that content. The WTRU 410 may build a user profile and may select an access network 406, 408 for the profile.

Within the access network 406, an access node 412 may apply a higher QoS to preferred content. A caching node 414 may cache preferred content, e.g., in priority. A border router or border node 416 may take content specialization into account for routing, for example, to an intermediate network 418.

A metadata service 420 may obtain metadata through crawling, e.g., by itself or using third party crawlers. The metadata service 420 may provide metadata associated with content objects or more advanced functions. For example, a rating may be calculated by the metadata service 420 instead of inside other nodes 422.

A publisher 424 may associate metadata with content.

Content specialization may refer to a set or a summary of tags (e.g., strings) that may be associated with a network. Tags may be associated with a weight.

Preferred content may refer to a content object or content objects for which a network operator may be willing to give a preferential level of service, such as preferential caching or QoS. Content specialization mechanisms may be used to enable this behavior.

Metadata may refer to a set of tags associated with a content object.

A vocabulary may refer to a set of possible metadata tags. Several vocabularies may be used, including a standard classification vocabulary and an open vocabulary, e.g., keywords.

A metadata summary may be a compressed form of the metadata associated with an object or a network content specialization. A Bloom Filter may be used for compression.

Rating may be the result of a function estimating the match between a content object and the content specialization of a network.

Metadata may be represented in a network. Metadata representations may include metadata of a single content object. Metadata representations may include metadata of a group of objects, e.g., of a domain or subdomain of a publisher, or metadata of a scope in some ICN naming schemes. Content objects published in a group may share common metadata attributes. Metadata representations may include metadata relating to specialization of a network. This metadata may be a larger set of metadata attributes, which may comprise the specialization of the network.

Metadata may use generalized and/or specialized standard vocabularies. Open vocabularies. e.g., keywords, may be set by publishers or extracted by crawlers. Automated handling of content based on content specialization may use a common vocabulary expressing the content specialization on one side and the object metadata on the other side. A conversion from an open vocabulary to a closed vocabulary may be performed.

Content specialization vocabularies may focus on classification of content objects. For certain ranges of usage, e.g., advertisement to users or routing, specialization vocabularies may also apply to a more general classification of content, such as the type of services provided or preferred or the type or types of resources available through a network.

A network element may store a full representation of the network representation. A full representation may make it possible to build a summary and to remove or add metadata labels and then rebuild a new summary. A full representation can include structured text, such as XML or Json. Equivalent binary representations may be used as well. Because the metadata vocabulary may be fragmented in different schemes, it may be appropriate to divide a full representation into one or more scheme-specific components. Each such component may have an information element representing the scheme specification and a set of information elements that may represent individual metadata entries from this scheme specification.

Other information may be attached to tags, such as, for example, a weight, as shown in the following example:

<metadata>

<set vocabulary=”DDC”>

<label>516.375</label>
<label weight=12>632</label>
<label>7**</label>

</set>
<set vocabulary=”Publishers”>

<label>nbc.com</label>
<label>google.com</label>

</set>
<set vocabulary=”REL”>

<label>http://creativecommons.org/licenses/by-nc/3.0/<label>
<label>https://www.gnu.org/licenses/gpl.html<label>
<label>http://example.com/well/known/license/<label>

</set>

</metadata>

As shown in this example, wildcards may be used. For example, “7**” may match any Dewey Decimal Classification (DDC) tag in the range 700-799.

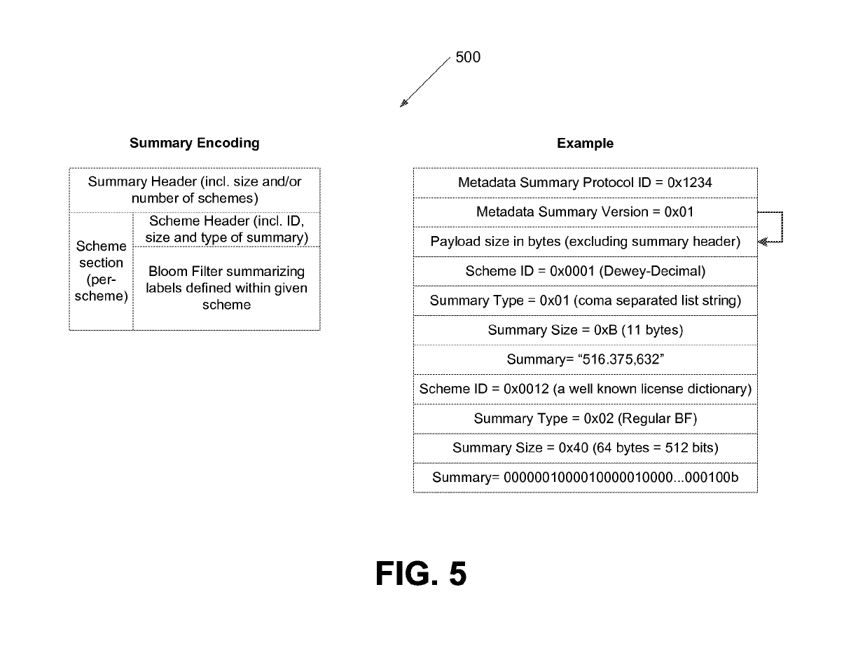

A full representation may not be well-suited to quickly rate a particular content object relative to the network specialization. A Bloom Filter may be used to summarize the set of information elements representing individual metadata entries for each specified scheme. FIG. 5 shows an example summary representation 500 that can be provided to every network element that may rate content (e.g., content cache, border router, access node). Such a summary representation can use a binary representation (e.g., to promote processing speed and information size), though an equivalent representation in structured text may be used.

Multiple scheme sections may be defined for the same scheme, e.g., to prevent the Bloom Filter fill rate from passing a threshold, e.g., in order to limit the risk of false positives. A summary type may be used to encode suitable types of summary, e.g., strings, regular BF, counting BF, etc.

Some metadata vocabularies may be compact, such as the Dewey Decimal Classification. These metadata vocabularies may be efficiently provided as strings as long as the number of entries is small. String representations may be suitable in content object messages. A limited number of entries may be used to describe a piece of content. On the other side, a network specialization's DDC may include many entries and may be more efficiently represented as a BF. In this representation, wild cards may be used when appropriate, e.g., in DDC lists.

A network may store a full representation of the network specialization as well as a summary representation of the network metadata. The full representation may be preprocessed to facilitate rating calculation, e.g., a Bloom Filter representation may be precalculated or may be cached once it is calculated a first time.

Metadata may be encoded in content requests and/or responses. For size and processing time considerations, metadata encoding in user plane traffic may be summarized and binary encoded.

Classification metadata may be encoded as an immutable classification, in which the classification may be an integral part of the name or content of the data object. In an immutable classification, changing the classification metadata may involve changing the name and/or the content object. For example, the classification metadata may be encoded as part of the name, e.g., /nbc.com/video/avatar may be encoded as/nbc.com/video/avatar/?1234ABCD, where the portion after the ‘?’ sign may be a text encoded summary of the content metadata. The classification data may be encoded as part of the object itself, e.g., a binary representation of the content metadata may be prepended before the content, as part of a new NDO header. It may be integrity-protected and not encrypted, to make it possible for the network to use this information. As another example, classification metadata may be included in the file format, e.g., in an MPEG-21 digital item description.

Classification metadata may be encoded as a mutable classification, in which the classification metadata can evolve without changing the content object or its name. The classification metadata may be bound to the content object in a secure way. For example, the classification metadata may be provided by a metadata lookup service. The classification metadata may form an additional component of the name, e.g., a scope component comprising a binary or text encoded summary of the content metadata. A content request may include this scope component as well as an ICN content name. The publisher may modify the metadata by re-publishing the content name with a different scope. The older scope may stay valid or become invalid after some time. The classification metadata may be encoded as an additional component besides the data object in the response. As in the immutable case, a new NDO header may be added to the object. This header may not be considered an integral part of the object. For example, the mechanism for protecting the content from tampering (e.g., signature, checksum) should not include the header. For example, border routers may modify the content of this header without altering the integrity of the NDO itself.

As another example, classification metadata may form part of an HTTP header, e.g., a header field that may be present in a request and/or a response. The metadata information may be, for example, a base64 representation of the binary metadata information. For example, in the case of a response as shown in the example below, the HTTP server may have the metadata information more directly from the publisher.

GET /nbc.com/audio/title.mp3 HTTP/1.1
Accept: audio/mpeg3
Accept-Language: en-us
Accept-Encoding: gzip, deflate
User-Agent: Mozilla/4.0
Host: som.example.com
Connection: Keep-Alive
Metadata: 1234ABCD
...
HTTP/1.1 200 OK
Content-Length: 30000
Content-Type: audio/mpeg3
Last-Modified: Thu, 12 Sep 2013 08:12:34 GMT
Accept-Ranges: bytes
Metadata: 1234ABCD
...

Classification metadata may form part of a multipart HTTP response, with one part including the text or binary representation of the metadata. Classification metadata may form part of a DNS message. For example, DNS information elements may be added to enable requesting metadata for a given content object, domain, or subdomain. A value may be defined for a Resource Record Type DNS information element. Values include 0x01 for “Host (A) record” and 0x02 for “Name server (NS) record.” A value 0x30 may be defined for “Metadata Summary.” This Resource Record Type may be used in both DNS request and response messages. A Metadata Summary resource record encoding may be used and may include, for example, information attached to tags, such as a weight. A metadata summary value of the Resource Record Type information element may be used to indicate the type of the record.

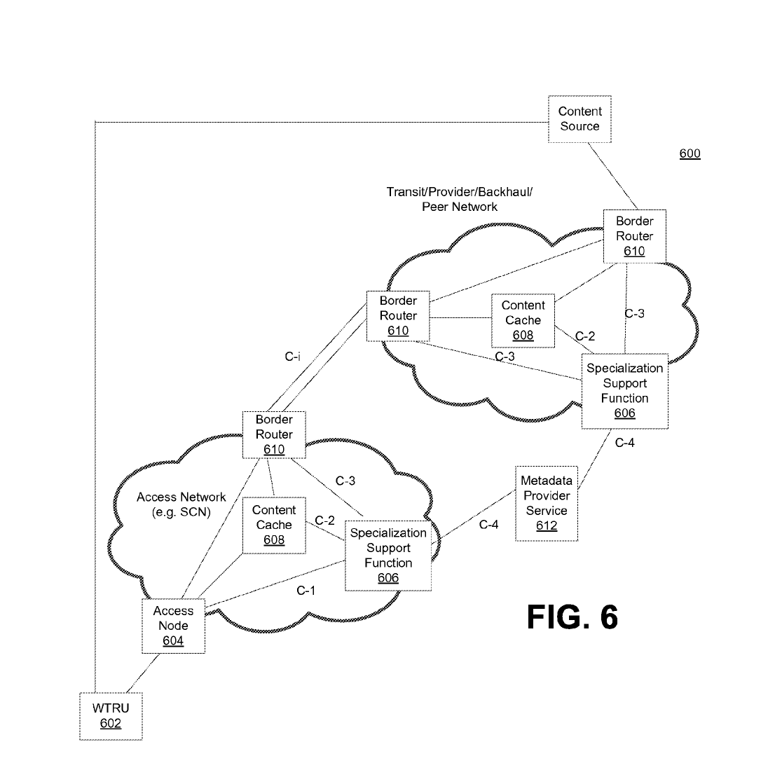

Any network domain, e.g., a set of interconnected networking devices under the control of an administrative entity, may support metadata-based specialization. FIG. 6 illustrates an example network 600 that may incorporate network functions and interfaces to enable metadata-based specialization.

A WTRU 602 may be an edge device, such as a smartphone, personal computer, web server, or the like. The WTRU 602 may be configured to collect and summarize metadata per user profiles and may use such profiles for network selection and/or requesting network recommendations. The WTRU 602 may be configured to collect specialization advertisements from access networks and use them for network selection.

An access node 604 may be the point of entry to the network 600 for edge devices such as the WTRU 602 and publishing servers (e.g., eNodeB, WiFi Access Point, etc.). The access node 604 may be configured to advertise network specialization. The access node 604 may collect metadata information from requests and/or responses passing through the access node 604, for example, with the assistance of a metadata lookup service. This may be done to apply differentiated levels of service or filtering or to send statistics to a Specialization Support Function subsystem 606. The Access Node 604 may route content requests through different virtualized or physical backend networks based on metadata information.

A Specialization Support Function (SSF) subsystem 606 may be a centralized or decentralized function. It can be partially or completely collocated with existing node(s). The SSF subsystem 606 may configure metadata specialization in other nodes. The SSF subsystem 606 may query an external service or services for metadata information for a name, domain name, etc. The SSF subsystem 606 may be used as a proxy for metadata information queries from other nodes.

The SSF subsystem 606 may process content metadata statistics from other network nodes, which may enable it to accumulate statistical data to facilitate communications with other networks. The SSF subsystem 606 may evaluate alignment of network specialization with users' behavior and may adjust specialization dynamically. The SSF subsystem 606 may maintain user profiles, which can be used to decide to redirect certain users to other networks, or provide them with recommendations based on currently cached content objects.

The SSF subsystem 606 may communicate with other networks' SSF subsystems, for the purpose of routing or other types of cooperation.

A content cache 608 may be a content router, for example, in ICN networks, or may be an HTTP proxy, for example, in an IP network. The content cache 608 may collect metadata information from a request, response, or service. The content cache 608 may make caching decisions based on a rating calculated based on metadata information related to content and/or configured metadata specialization. The content cache 608 may provide statistics on content requests and cache usage to the Specialization Support Function subsystem 606.

A border router 610 may be a border element of an ICN or non-ICN network domain. It may communicate with other networks (e.g., peers, provider or client networks) to exchange routing information, e.g., reachability information towards content publishers, content name publishers, or content scopes. The border router 610 may collect metadata information from requests or responses passing through the border router 610, for example, with the assistance of a metadata lookup service. BGP routers may make routing decisions based on rating of content relative to peers' specialization. The border router 610 may cooperate with other networks using network specialization. BGP routers may advertise network specialization to peers. CDNI gateways may advertise CDN specialization to other CDNs.

A metadata provider service 612 may be provided by publishers or third party service providers, or in a more centralized and controllable fashion, by a metadata aggregator. Large archives, such as arXiv and the CERN document server, may support OAI-PMH (Open Archives Initiative Protocol for Metadata Harvesting), a protocol that may be used to collect metadata descriptions of the records in an archive. Aggregator service providers, such as Google, can then use this protocol to collect information from many different archive services. An API may be provided for networks to get this metadata to support network specialization. The metadata provider service 612 may provide a metadata lookup service. The metadata provider service 612 may provide a discovery service (e.g., to help WTRUs discover suitably specialized networks). The metadata provider service 612 may provide a metadata rating service. The metadata provider service 612 may provide a specialization recommendation service.

The network 600 may include a number of control plane interfaces. These interfaces may enable network specialization related functionalities. The interfaces designated C-1, C-2, and C-3 on FIG. 6 may be similar to one another and may interface the SSF subsystem 606 and the network nodes. The SSF subsystem 606 may use the C-1, C-2, and C-3 control interfaces to configure network nodes with the network specialization. The network nodes can send statistics to the SSF subsystem 606 using the C-1, C-2, and C-3 control interfaces. Using these control interfaces, the network nodes can query metadata information through the SSF subsystem 606. The network nodes may also directly query a metadata service.

In the example network shown in FIG. 6, the SSF subsystems 606 of different networks do not dialog directly with each other, instead obtaining information from other networks from the border routers 610. SSF subsystems 606 of different networks may have a direct interconnection to one another.

A C-4 control interface between the SSF subsystems 606 and the metadata provider service 612 may be used to query the metadata provider service 612, e.g., for metadata information lookup, rating, discovery, and recommendation. Direct interfaces may be implemented between network nodes or between the WTRU 602 and the metadata provider service 612; these direct interfaces are omitted from FIG. 6.

A C-i control interface between border routers 610 can, for example, use BGP or CDNI signaling protocols. This interface may implement various network-specialization-aware functions. BGP routers can exchange network specialization over BGP extensions. CDNI gateways can exchange CDN specialization over enhanced CDNI.

User plane interfaces, which are not depicted in FIG. 6, may communicate messages that may include information elements storing metadata information.

FIG. 6 depicts a general network architecture. Specific substrate content networks may use particular network configurations. For example, the usage of content specialization may be different in an ICN network as compared with an IP end-to-end network. Border routers may be content-aware in ICN networks, but may be content-unaware in an IP network. ICN architectures may vary in some aspects, such as route-by-name or lookup-by-name. In route-by-name approaches, intermediate nodes may use the content name to decide where to route a request. In lookup-by-name approaches, a first lookup of a content name may return a locator (e.g., an IP address) of a source or a cache.

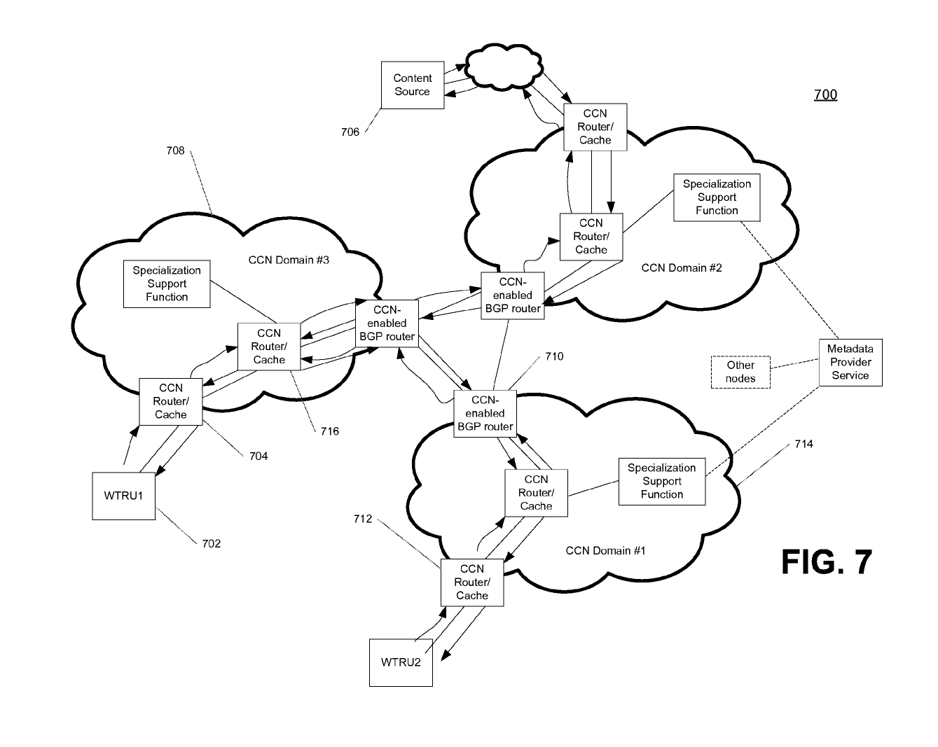

FIG. 7 depicts an example content centric network (CCN) 700 in which content specialization may be implemented. Content centric networking is an example ICN system design oriented around a route-by-name approach. In FIG. 7, solid lines represent point-to-point connections between neighboring devices. Dashed lines represent application layer communication paths. Some communication paths may be omitted from FIG. 7 for clarity.

A WTRU 702 may send a content request (e.g., in this context, a CCN interest message) to its neighbor CCN router/cache 704. The interest packet may be propagated in the network 700 towards a content source 706 and/or cached copies, based on a routing state maintained in the routers. In CCN, this routing state may be the Forwarding Information Base. The content request may be for a new content object that is not yet cached in the network. The interest packet may reach the content source 706.

The content source 706 may send back a content response that may include the content object. The content response may be forwarded back to the requester, using the state that has been maintained in the router or caches while forwarding the content request. In CCN, the reverse path routing state may be the Pending Interest Table. An intermediate content router may decide to cache the content object.

A content router or cache 716 in a CCN domain 708 may rate the content object and may determine that it is a preferred content object, fitting the content specialization of the CCN domain 708, which may have been earlier communicated to the router by the Specialization Support Function subsystem. The content router/cache may decide to cache the object, for example, following a longer term caching policy than for non-preferred content.

After the content object reaches the initial requester, e.g., the WTRU 702, another WTRU 710 may request the same content object. A border router 712 of a CCN domain 714 may rate the content object metadata relative to content specializations of neighboring networks (e.g., all neighboring networks) and may discover that the CCN domain 708 is the best match for this request. The border router 712 may decide to forward the request toward the CCN domain 708. The border router 712 may decide to forward the request toward more than one domain, e.g., the two domains with highest ratings for a given content object.

The content request may reach a router/cache 716 in the CCN domain 708, which may have the object in a long-term cache. The router/cache 716 may reply with the content object. The content object may reach the requester, e.g., the WTRU 710.

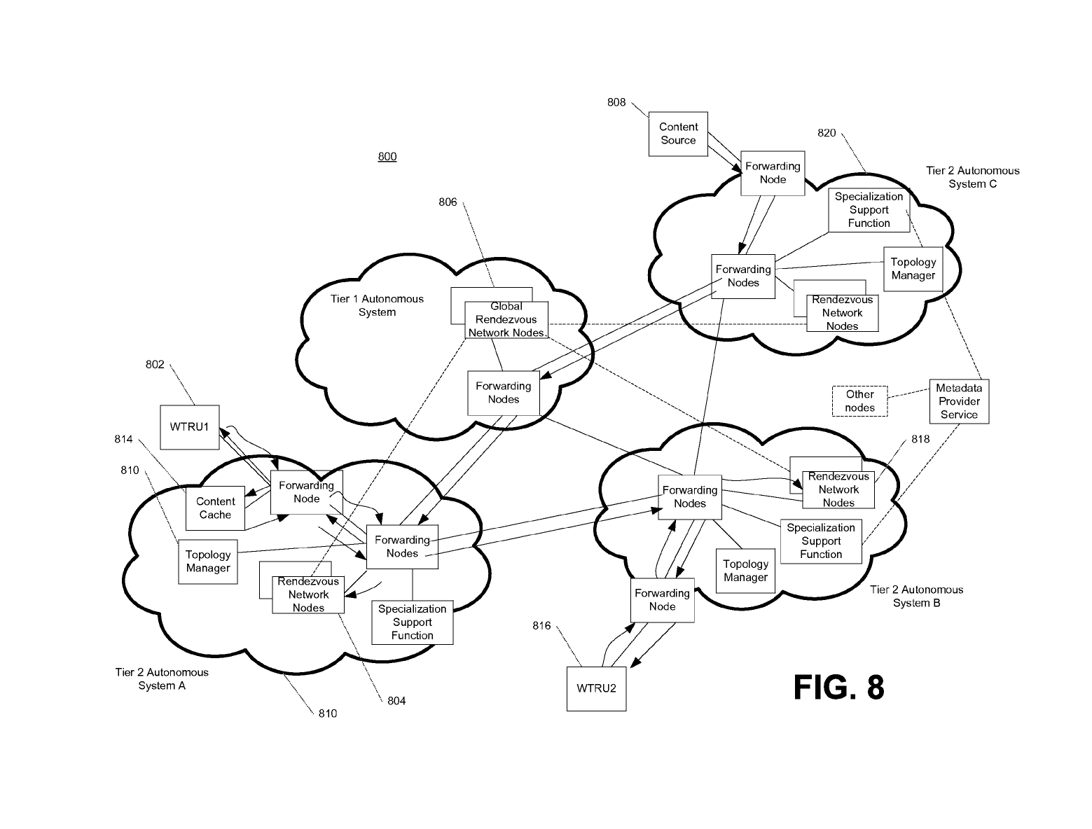

FIG. 8 depicts an example Publish Subscribe Internet Routing Paradigm (PSIRP) network 800 in which content specialization may be implemented. PSIRP is an example ICN system design oriented around a lookup-by-name approach. In FIG. 8, solid lines represent point-to-point connections between neighboring devices. Dashed lines represent application layer communication paths. Some communication paths may be omitted from FIG. 8 for clarity.

In the example network 800, a WTRU 802 may send a content request, e.g., a subscription message containing a content name, toward a local name resolution network (NRS), e.g., a local rendezvous network 804. The local rendezvous network 804 may include the local network content specialization information element in registration messages sent to a global rendezvous network 806.

The local rendezvous network 804 may attempt to match the subscription locally, then (if the attempt fails) forward the subscription to the global rendezvous network 806. The global rendezvous network 806 may locate a network domain that has previously registered for the requested object and may forward the content request towards this domain's rendezvous network, which may then communicate with the topology manager of the domain to establish a path for the data on the forwarding plane. For simplicity, this signaling is not shown, since this is the normal behavior of the PSIRP system. The local rendezvous network 804 may associate classification metadata with the content names. For example, the publishers may provide this information when publishing the content objects, and/or the metadata information may be obtained by crawling through the published resources and analyzing the content objects. The local rendezvous network 804 may receive content specialization information from other networks' local rendezvous systems.

A content source 808 may send the content object over a defined path, for example, by including a path ID provided by a topology manager in the data packets, as per the normal behavior of PSIRP systems.

The topology managers of traversed domains (e.g., all traversed domains) may be involved in define a proper path through their domains (as per the normal behavior of PSIRP systems). The topology manager 810 of a domain 812 may support content specialization. The topology manager 810 may rate the content object's metadata relative to the content specialization of the domain 812. In this example, this rating may be high and the topology manager 810 may make the decision to forward the content object not only to the requester, but additionally towards an in-network content cache 814. The in-network content cache 814 may store the content and may publish its location to the rendezvous system.

The content object may reach the original requester, e.g., the WTRU 802, as well. Later, a second WTRU, e.g., a WTRU 816, may request the same content object. The request may reach a local rendezvous network 818, which may forward the request to the global rendezvous network 806. The global rendezvous network 806 may be aware of the content specialization of individual networks. The content object can be retrieved from the domain 812 or a domain 820. The global rendezvous network 806 may rate the content object metadata relative to the content specializations of domains 806 and 820 and may select a publisher from the highest rated domain, e.g., the content cache 814 of domain 806. The content object may then be sent by the content cache 814 to the WTRU 816 following the usual PSIRP procedure, for example.

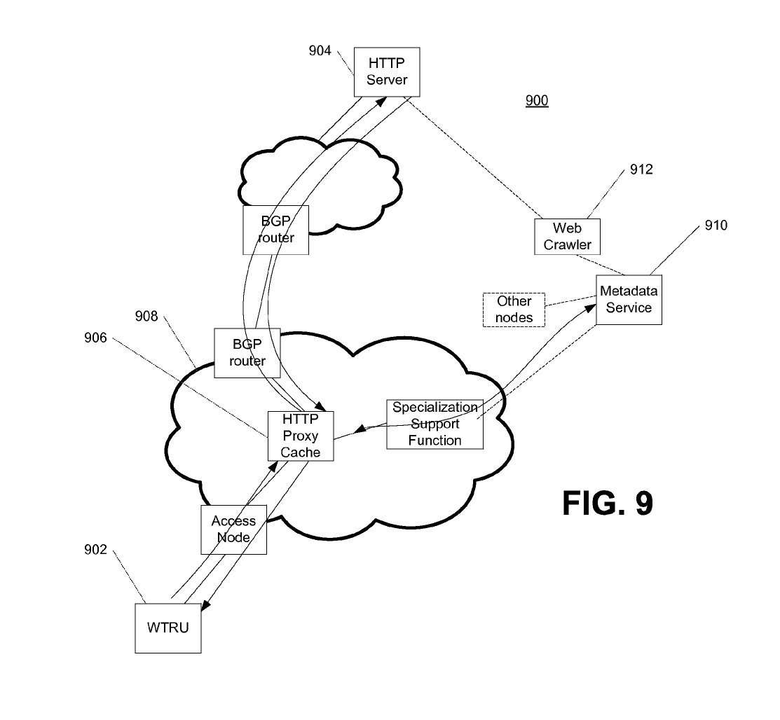

FIG. 9 depicts an example access IP network 900 deploying an HTTP proxy cache. Content specialization may be implemented in such a network. In FIG. 9, solid lines represent point-to-point connections between neighboring devices. Dashed lines represent application layer communication paths. Some communication paths may be omitted from FIG. 9 for clarity.

In the example network 900 of FIG. 9, a WTRU 902 may send a content request (e.g., an HTTP GET request) toward an HTTP server 904 and through an HTTP proxy cache 906 located in the access network 908. The HTTP proxy cache 906 may forward the request to the HTTP server 904, assuming the requested object is not yet cached. The HTTP server 904 may send back the content object in an HTTP response message.

The HTTP proxy cache 906 may forward the object and may temporarily cache the object. The HTTP proxy cache 906 may request metadata information from a metadata service 910. The metadata service 910 may obtain this metadata ahead of time, e.g., from a service 912 crawling and analyzing web resources for metadata. The metadata service 910 may return classification metadata to the HTTP proxy cache 906, which can then rate it relative to the content specialization of the network. If the result is above a threshold, the content object may be considered preferred by the HTTP proxy cache 906, and a specific (e.g., longer-term) caching policy may be applied for this object. The content object may be received by the original requester, e.g., the WTRU 902.

Differentiated caching and quality of service (QoS) may be enabled based on content specialization. Once the network has determined a specialization, e.g., a set of metadata values, an intermediate node, such as a cache or an access node, may be able to rate how interesting (e.g., in regard to the network specialization) a content object is and may be able to use this information to influence caching and QoS policy. Metadata may be obtained from a lookup service, or it may be part of the content object itself, in which case using a lookup service may be omitted. The network provider SSF subsystem may use an API offered by the metadata lookup service and may use the content name (e.g., ICN name or URI) as a key.

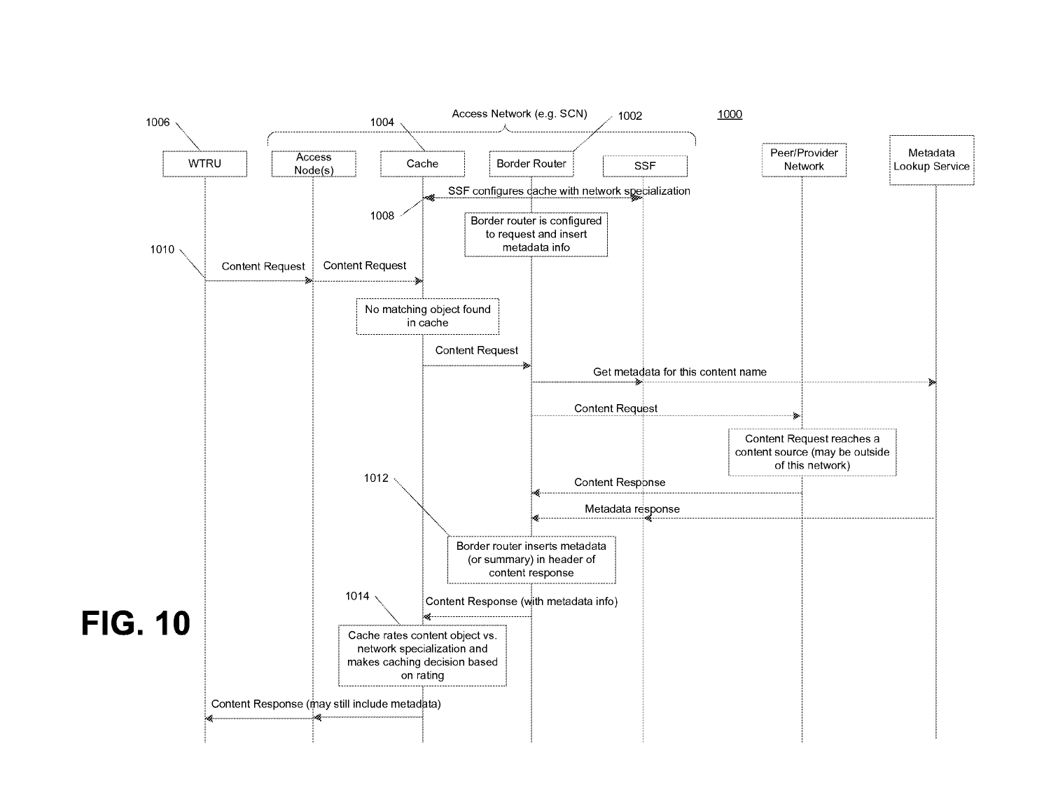

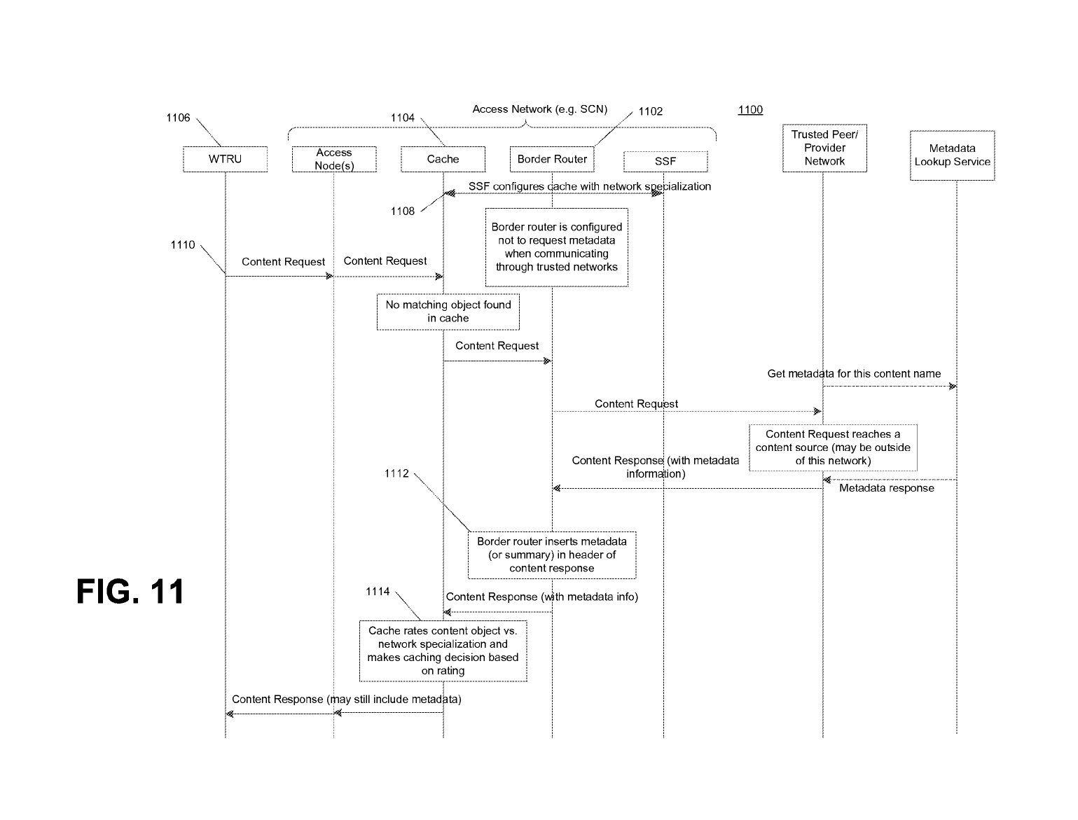

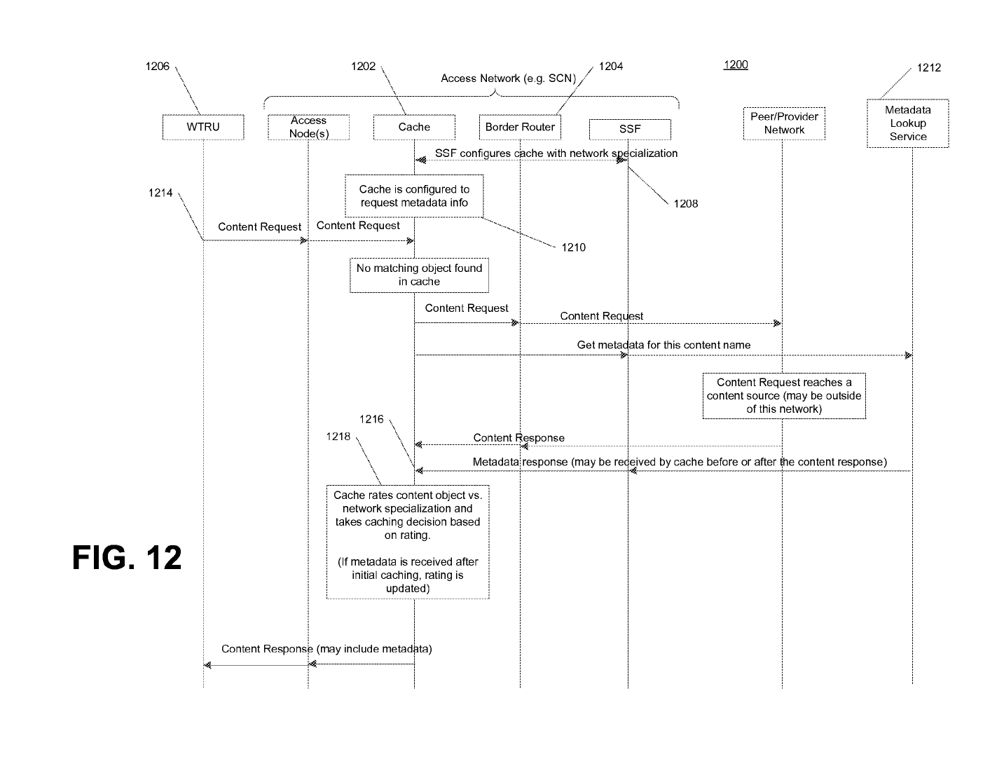

In the example of FIG. 10, a border router may obtain metadata. In the example of FIG. 11, the access network may trust a peer or provider network or content source and may assume that the received content object may store metadata information. In the example of FIG. 12, a content cache may obtain the metadata. These examples illustrate caching employed for content specialization.

Enhanced quality of service may be provided for preferred content. Metadata may be attached to a content request or content response or may be obtained from a metadata service at various levels. The rating maybe calculated in the network nodes (e.g., border router, cache, or access node) or by a service operated by a third party or by an access network operator.

FIG. 10 illustrates an example message flow 1000 for differentiated caching, for example, in a cellular network. The message flow 1000 may apply to ICN networking, in which the content request may be an interest packet including the content name. The message flow 1000 may apply to IP networking, in which the content request may be a DNS resolution request or an HTTP GET request.

The border router 1002 may be an enhanced BGP or other network element communicating with other network domains. In DONA, for example, this could be a resolution handler. In the IP networking case, this could be an HTTP Proxy or a CDNI gateway, e.g., a network element aware of the content object. The cache 1004 and the border router 1002 may be the same entity. In another example of the IP networking case, the content request may be a DNS request (e.g., for a sub-domain such as video.nbc.com). The cache/border router element in this case may be the DNS resolver of the access network. In this DNS case, the DNS response may not contain the object, and the content object may not be cached, even if the DNS response is cached. The WTRU 1006 may fetch the content object over an IP connection to the source designated by the DNS resolution response.

At 1008, caches may be configured with the network content specialization. This may be a list of the preferred topics part of the specialization, e.g., the full representation, rather than a summary.

At 1010, a content request may be sent. If the WTRU 1006 knows (or obtains prior to sending the request) the metadata associated with the object, a metadata summary may be included in the request. An intermediate node may request a metadata summary for the content object (or for the domain or subdomain where the object was published). In this example, it may be assumed that the WTRU did not insert metadata in the request, and that the border router 1002 of the access network may perform this metadata request. One efficient way to do this, as depicted, may be to request metadata in parallel with the content request.

At 1012, the border router 1002 may insert metadata into the content response message, for example, in ICN, by inserting a new header field encoded as described herein.

This metadata can then be used by any intermediate node in the access network, such as the cache 1004. At 1014, the cache 1004 may rate the content object metadata relative to the content specialization of the network and may use this rating information to influence the caching of the object. This metadata may either be removed by an intermediate node, or it may reach the WTRU 1006. The WTRU 1006 may use this metadata information to build a user profile, as described herein.

FIG. 11 illustrates an example message flow 1100 for differentiated caching, for example, in a cellular network. In the example of FIG. 11, the access network may trust the peer/provider network and may accept metadata information attached to the content responses coming from the peer/provider network. The way in which the peer/provider network obtains the metadata information may not be relevant for the access network. For example, the peer/provider network may obtain the metadata information from a metadata lookup service, as shown in FIG. 11. The message flow 1100 may apply to both ICN and non-ICN networking.

The border router 1102 may be an enhanced BGP or other network element communicating with other network domains. In DONA, for example, this could be a resolution handler. In the IP networking case, this could be an HTTP Proxy or a CDNI gateway, e.g., a network element aware of the content object. The cache 1104 and the border router 1102 may be the same entity. In another example of the IP networking case, the content request may be a DNS request (e.g., for a sub-domain such as video.nbc.com). The cache/border router element in this case may be the DNS resolver of the access network. In this DNS case, the DNS response may not contain the object, and the content object may not be cached, even if the DNS response is cached. The WTRU 1106 may fetch the content object over an IP connection to the source designated by the DNS resolution response.

At 1108, caches may be configured with the network content specialization. This may be a list of the preferred topics part of the specialization, e.g., the full representation, rather than a summary.

At 1110, a content request may be sent. If the WTRU 1106 knows (or obtains prior to sending the request) the metadata associated with the object, a metadata summary may be included in the request. An intermediate node may request a metadata summary for the content object (or for the domain or subdomain where the object was published). In this example, it may be assumed that the WTRU 1106 did not insert metadata in the request. In the example of FIG. 11, the border router 1102 may be configured not to request metadata when communicating through trusted networks. The metadata may be requested by a peer/provider network trusted by the access network and provided by a metadata lookup service.

At 1112, the border router 1102 may insert metadata into the content response message, for example, in ICN, by inserting a new header field encoded as described herein.

This metadata can then be used by any intermediate node in the access network, such as the cache 1104. At 1114, the cache 1104 may rate the content object metadata relative to the content specialization of the network and may use this rating information to influence the caching of the object. This metadata may either be removed by an intermediate node, or it may reach the WTRU 1106. The WTRU 1106 may use this metadata information to build a user profile, as described herein.

FIG. 12 illustrates an example message flow 1200 for differentiated caching, for example, in a cellular network. In the example of FIG. 12, a cache 1202 may request metadata. The message flow 1200 may apply to ICN networking, for example, in which a content request may be an interest packet including a content name, and to non-ICN networking, in which a content request may be an HTTP GET request. The message flow 1200 may be resilient to variations of delay between metadata and content response. For example, if the metadata is received first, the cache 1202 may wait for the content object to proceed with rating and caching on one side and forwarding on another side. If the object is received first, it may be forwarded and cached as a non-preferred object, e.g., with a rating of 0. When the metadata is received, the rating may be calculated, and the status of the cached object may be updated accordingly. The new rating may be taken into account for the caching priority of the object.

The border router 1204 may be an enhanced BGP or other network element communicating with other network domains. In DONA, for example, this could be a resolution handler. In the IP networking case, this could be an HTTP Proxy or a CDNI gateway, e.g., a network element aware of the content object. The cache 1202 and the border router 1204 may be the same entity. In another example of the IP networking case, the content request may be a DNS request (e.g., for a sub-domain such as video.nbc.com). The cache/border router element in this case may be the DNS resolver of the access network. In this DNS case, the DNS response may not contain the object, and the content object may not be cached, even if the DNS response is cached. The WTRU 1206 may fetch the content object over an IP connection to the source designated by the DNS resolution response.

At 1208, caches may be configured with the network content specialization. This may be a list of the preferred topics part of the specialization, e.g., the full representation, rather than a summary.

At 1210, a cache may be configured to request metadata information, for example, from a metadata lookup service 1212.

At 1214, a content request may be sent. If the WTRU 1206 knows (or obtains prior to sending the request) the metadata associated with the object, a metadata summary may be included in the request. An intermediate node may request a metadata summary for the content object (or for the domain or subdomain where the object was published). In this example, it may be assumed that the WTRU 1206 did not insert metadata in the request.

At 1216, the metadata lookup service 1212 may return a metadata response to the cache 1202. This metadata can then be used by any intermediate node in the access network, such as the cache 1202. At 1218, the cache 1202 may rate the content object metadata relative to the content specialization of the network and may use this rating information to influence the caching of the object. This metadata may either be removed by an intermediate node, or it may reach the WTRU 1206. The WTRU 1206 may use this metadata information to build a user profile, as described herein.

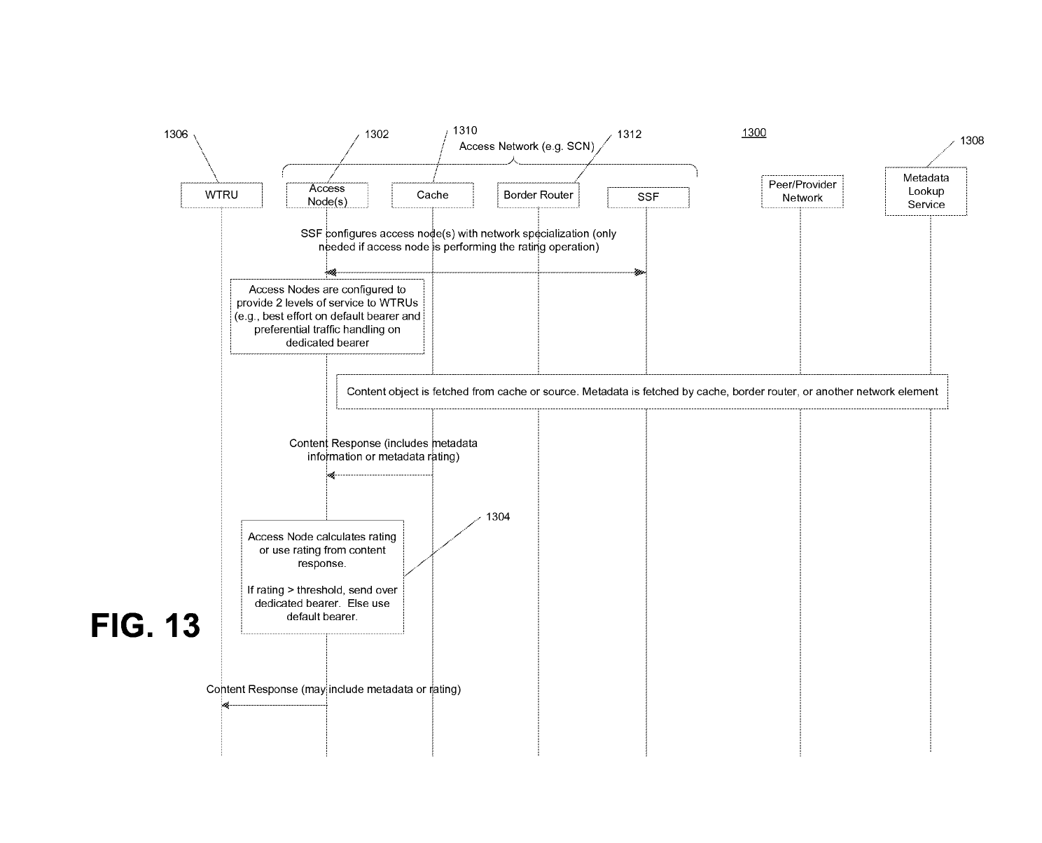

FIG. 13 illustrates an example message flow 1300 for differentiated quality of service (QoS), for example, in a cellular network. The message flow 1300 may apply to ICN networking, for example, in which a content request may be an interest packet including a content name, and to non-ICN networking, in which a content request may be an HTTP GET request. FIG. 13 illustrates an example of how an access node (e.g., eNodeB, WiFi Access Point) may use the metadata associated with a content object. This example may be combined with one or more of the examples shown in FIGS. 10-12. Upon reception of the content object associated with the metadata, the access node 1302 can calculate a rating at 1304, which may be used to decide with which quality of service to transport the object to the WTRU 1306, e.g., over which bearer in the case of a cellular network. The access node 1302 may request the metadata from a metadata lookup service 1308. The content object message may include (e.g., explicitly include) a rating of the object, which may be calculated by another entity such as a cache 1310, a border router 1312, or the metadata lookup service 1308.

The cache 1310 (e.g., and possible access nodes for level of service selection) may implement a rating function using as input the summarized network specialization summary NS and the metadata OM associated with the content object. The network specialization summary NS may be a list of schemes and a list of applicable metadata labels from this scheme (e.g., the full representation). The metadata OM may include a list of schemes. Each scheme may be associated with a summary of labels from this scheme. This summary can be a Bloom Filter.

The rating function output can be binary (e.g., present/not present) or a non-negative value, which may or may not be normalized. The output of this function may be 0 if there is no common tags between both inputs, and may be greater than 0 in other cases. In the case of a non-binary rating function output, the value of the output may represent how well the content matches the network specialization. For example, the output may increase as the amount of matched tags increases.

The rating function may be implemented, for example, as follows. The cache may discard from OM any scheme that is not in NS. If there are no schemes left in OM, the rating may be set to 0. If there are schemes left in OM, then for each scheme n (where n varies from 1 to the number of common schemes N), alternative cases may be considered.

In one case, the summary for a scheme n may be a list of tags (e.g., Dewey Decimal Classification (DDC)). R(n) may be initially set to 0 and may be incremented as R(n)=R(n)+1 for each match found between any two tags, where a match may be defined as equality between strings with the possibility of character wildcard matching. R(n) may be incremented as R(n)=R(n)+w for each match found between any two tags, where w is the weight associated with the tag in NS, if any.

In another case, the summary for a scheme n may be a Bloom Filter. Bloom Filter entries for each individual tag in the network specialization summary may be pre-calculated as BF(tag). R(n) may be initially set to 0 and may be incremented as R(n)=R(n)+1 for each BF(tag) found present in OM. Some rating methods may count common bits between Bloom Filters in OM and NS.

A final rating R=max(R(n)) for n from 1 to N may be calculated. For example, the final rating R may be the maximum rating for all considered schemes. Some rating methods may use different approaches for calculating the final rating R, such as the mean value, median value, sum, etc. instead of the maximum value.

A binary rating function may be derived, by stopping the process at any stage where a match is found and setting R=1 (e.g., present), but setting R=0 (e.g., not present) if no match is found.

Rating of open vocabularies (e.g., hashtags) may be more complex because the equivalence between tags may be considered, e.g., “sport,” “sports,” “sportive,” and “deported” (Spanish translation of the word sport) may be considered equivalent terms. Tags from open vocabularies may bring the possibility of ambiguity. For example, “football” which can be either “soccer” or “American football,” depending on the context.

Open vocabulary metadata may be converted to a closed vocabulary equivalent by the metadata service provider. The rating function described herein can be used. This pre-processing can be performed by metadata service providers, for example, with a combination of web crawling and on-request processing. In web crawling, content objects discovered by crawlers may be fetched, and their metadata and/or content body may be analyzed, to classify the content using one or more standard vocabularies. In on-request processing, when a metadata service provider receives a request for an unknown content object, it can also trigger this operation on the spot (e.g., the content object name may be queued for processing, and in the meantime the service can reply that this object is not yet processed).

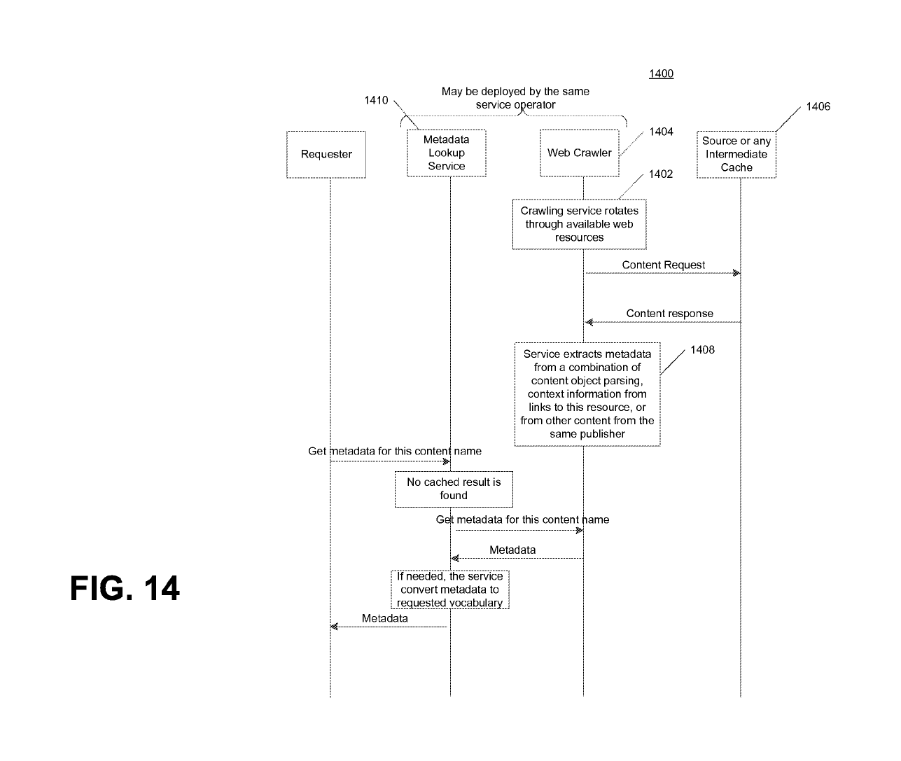

Converting open vocabulary metadata to a closed vocabulary equivalent may facilitate reducing the effort from the content producer, while limiting the amount of processing required to perform rating of content, which may enable line-speed operations in the network. Even if the content producer uses a closed vocabulary for classification of its content, this classification may be translated to another vocabulary, e.g., because the content specialization of the network operator may be expressed in this second vocabulary. The metadata service provider can perform this conversion, and may offer an API to the network providers. The network provider may express in which vocabularies the responses should be expressed. The conversion from open to closed vocabulary, instead of being performed by the metadata service operator, may be performed by the access network operator, or by a third party service. Organizations deploying web crawlers, such as Google, may be in a good position to deploy metadata services that may be able to analyze content metadata and data to classify objects and provide this classification information through an API, as depicted in the example message flow 1400 shown in FIG. 14.

FIG. 14 depicts an example message flow 1400 that illustrates how a web crawler may be used to implement a metadata lookup service. The publisher may omit associating specific metadata information in a content object. At 1402, a web crawling service 1404 may rotate through available web resources and may issue content requests to and receive content responses from a source or an intermediate cache 1406. At 1408, the web crawling service 1404 may extract metadata, e.g., from a combination of content object parsing, context information from links to the resource, and/or from other content from the same publisher. The web crawling service 1404 may also retrieve metadata from a metadata lookup service 1410.

Referring again to FIG. 13, based on the rating function output, the cache 1310 may make a caching decision. The rating can continue to be internally attached to the stored data object, in such way that cache replacement may consider ratings of stored object when deciding which object or objects should be deleted from the store.

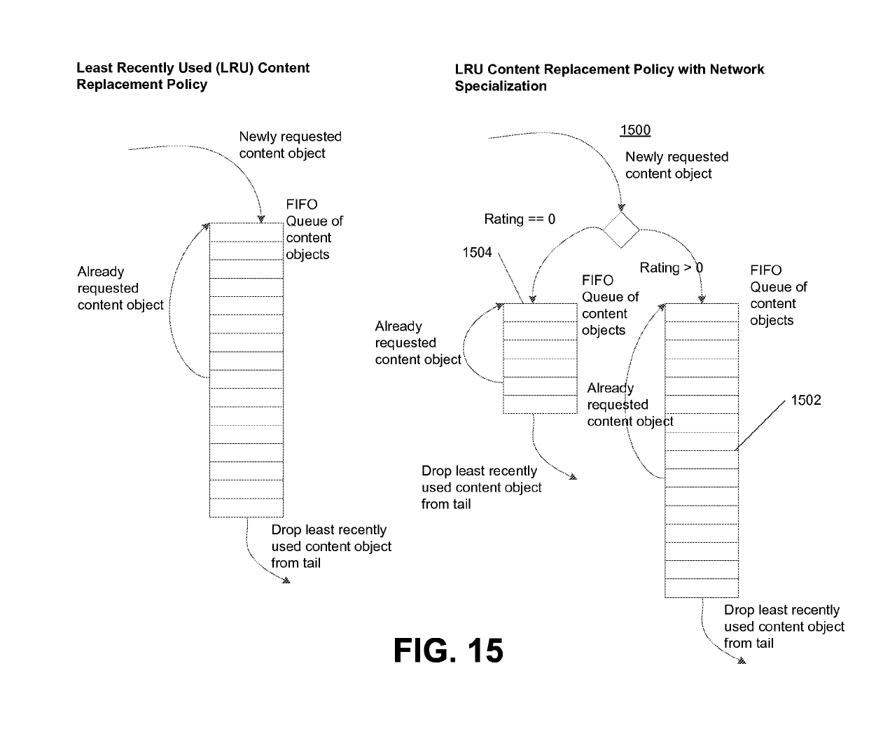

FIG. 15 illustrates an example Least Recently Used (LRU) content management approach, which may be based on a First In First Out (FIFO) queue. A LRU scheme 1500 can take into account network specialization based ratings by dividing the cache storage space in 2 or more sections. For example, a first portion 1502, e.g., 75%, of a storage space, may be allocated for content objects having a rating>0, and a second portion 1504, e.g., 25% of the storage space, may be allocated for the rest, e.g., for content objects having a rating less than or equal to 0. Each portion may use an independent LRU scheme.

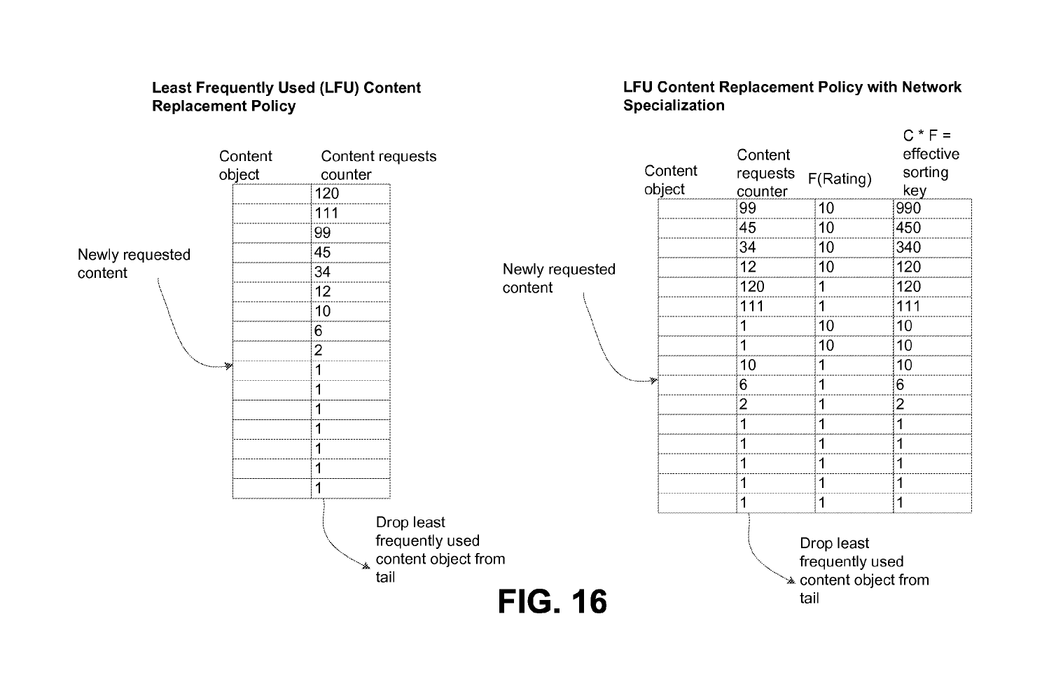

FIG. 16 illustrates an example Least Frequently Used (LFU) content management approach, in which a counter may be maintained for each object. Network specialization based ratings may be considered by using such ratings to manipulate the counters. For example, for sorting purposes, instead of considering the counter, the value counter*((F(rating)*A)+B) may be used, where A and B may be parameters that may be set to achieve a balance between specialized content and other content in the cache and F(rating) may be a function applied to the rating. For example, F(rating) may have a value of 1 if rating has a value of 0 and may have a value of 5 if rating has a value greater than 0. Configuring F(rating) in this way may have the effect of longer retention of content related to the network specialization, while keeping in the cache non-specialized content that is popular.

Metadata information may be present in the content response. For example, metadata information may be inserted by the publisher. In this case, the lookup service may be omitted. The lookup service may still be used to check the accuracy of the information provided by the publisher.

Metadata information may also be obtained for a domain name or, more generally, for a scope. For example, all content provided by a given domain “ifffootball.com” can be tagged as related to sport, more precisely football. Similarly, all names under the prefix “nbc.com/sports” may be tagged as sport-related metadata.

If metadata cannot be obtained for a data object (or if it cannot be obtained on time), then the data object response may still be forwarded towards the WTRU, either without any metadata information element, or with an empty metadata information element. In either case, the cache may find a rating of 0 and may make a caching decision based on this rating.

It will be appreciated that, while certain examples disclosed herein are discussed in the context of an access network, they may be applicable to a transit network. For example, in FIGS. 10-12, the access nodes may be replaced with a border router. Further, while certain examples disclosed herein are discussed in the context of an Information Centric Network (ICN), they may apply equally to an IP network for HTTP traffic, where the cache may be a proxy HTTP cache.

Different weights may be allocated to different metadata labels (e.g., a SCN serving a stadium may specialize in “sport” content with a weight of 1 and in “soccer” or “athleticism” content with a weight of 2). This weight may, for example, be taken in consideration when calculating the rating.

In a Name Resolution System based inter-domain architecture, such as in NetInf, PSIRP or DONA ICN architectures, the name resolution system may store metadata along with locators associated with a certain content name. For example, the entity registering the name-locator binding may include the metadata information as well. As another example, the first registration (e.g., only the first registration) may include metadata information, which may be used for all copies of the object. As a result, any node potentially interested in caching the data object may request its metadata information from the NRS, and may calculate its rating relative to the specialization of the cache.

Network operators may use one or more of a number of criteria to determine which content specialization may be used for their network or networks. A criterion may relate to a business context and/or location. For example, for a network deployed in a stadium, a network operator may give preferential handling to content related to sports and/or events occurring in the stadium. A criterion may relate to date and/or time. For example, a stadium network operator may change its content specialization depending on the event occurring that day, e.g., “sport” during a football match or “music” during a rock concert.

A criterion may relate to network conditions. When the network access becomes overused, the network operator may restrict the content specialization of the network to a narrower focus (e.g., from “Sport” to “Football”), so that the quality of experience of users remains acceptable when accessing content most relevant to the operator's goals.

A criterion may relate to users' profiles. A network operator may collect usage statistics from its end users (e.g., classification of content requested over a certain time period), and then determine a content specialization that fits the most represented topics, or the most relevant to the network operator's goals.

A criterion may relate to other networks sharing the same footprint. A network operator may select its content specialization based on information about other overlapping networks. For example, a network operator may select complementary topics that are not well represented in overlapping networks in order to appeal to end users that are not well served by other networks. The network operator may select topics already well represented in overlapping networks in order to offer a competing solution, or simply to add capacity.

Network advertisements may be delivered to users. For example, a cellular network may support advertising network specialization. LTE networks may support broadcasting system information (e.g., Master Information Blocks (MIBs) and System Information Blocks (SIBs)) to WTRUs. System information may include cell bandwidth, PLMN ID, cell ID, and the like. The WTRU may use this information, for example, to select the network and synchronize itself with the network. The eNodeB may broadcast system information and may obtain most of the system information from the MME in an MME configuration update message.

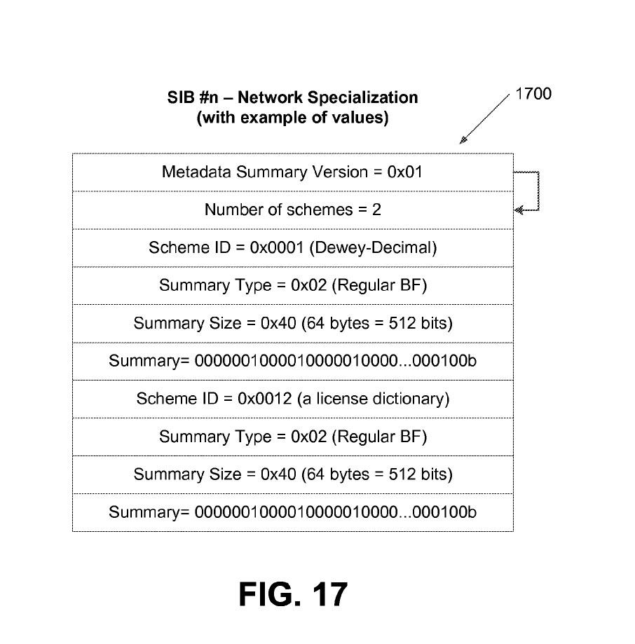

A given network operator may operate multiple small cell networks (SCNs), each of which may have a different specialization. FIG. 17 illustrates an example System Information Block (SIB) format 1700 that may include network specialization information.

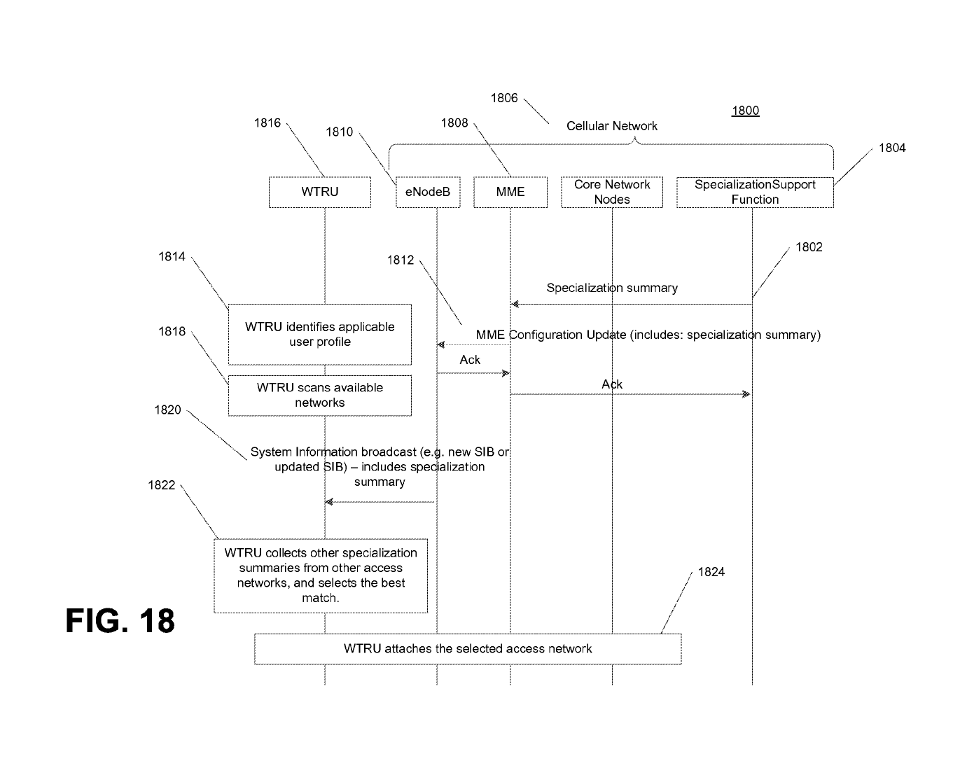

FIG. 18 illustrates an example message flow 1800 for using network specialization advertisements by cellular networks by WTRUs to determine which network to attach to. At 1802, a specialization support function (SSF) subsystem 1804 of a cellular network 1806 may send a specialization summary to an MME 1808. The MME 1808 may send a configuration update, which may include the specialization summary, to an eNodeB 1810, at 1812. At 1814, a WTRU 1816 may identify an applicable user profile. At 1818, the WTRU 1816 may scan available networks. At 1820, the WTRU 1816 may receive a system information broadcast, which may include the specialization summary. At 1822, the WTRU 1816 may collect other specialization summaries from other access networks and may select the best match. At 1824, the WTRU 1816 may attach to the selected access network.

Network advertisements may be delivered from WiFi networks. 802.11u may support advertising network specialization to end users before any association takes place. For example, an Access Network Query Protocol (ANQP) information element “Network Specialization” (NS) may be created and may be provided to mobile nodes over a Generic Advertisement Service (GAS) protocol. Network specialization may be associated with a specific, Network Access Identifier (NAI) Realm, since a single AP may be used to access more than one network. One such Network Specialization information element per network may be included in ANQP messages sent to the WTRU.

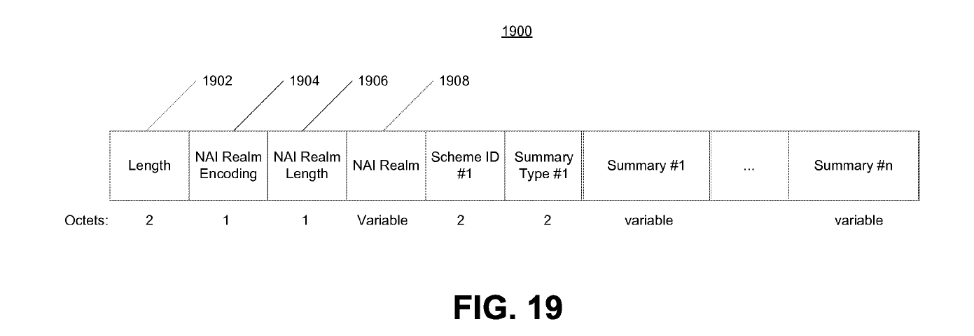

FIG. 19 illustrates an example ANQP network specialization information element 1900. The information element 1900 may have a Length field 1902 that may store the number of bytes in the message. A number of fields, e.g., three fields 1904, 1906, 1908, may be used to identify the networks that has the given specialization. These fields (e.g., NAI realm encoding, NAI realm length, NAI realm) may be defined in the 802.11u specification. Other fields may describe the network specialization.

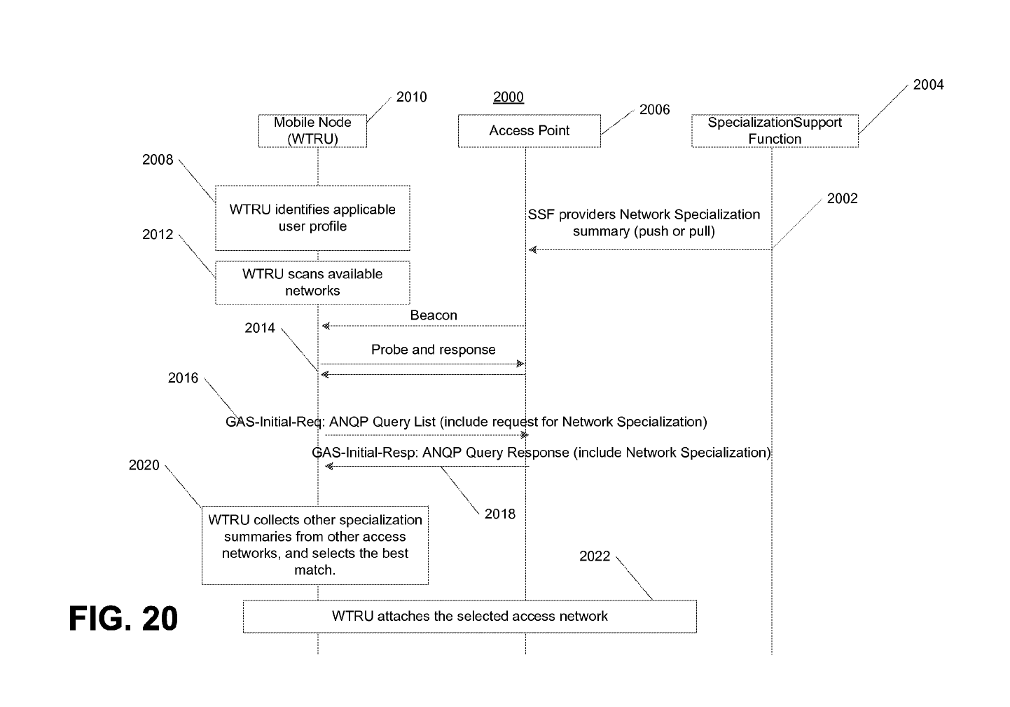

FIG. 20 illustrates an example message flow 2000 for using network specialization advertisements by WiFi networks by WTRUs to determine which network to attach to. At 2002, a specialization support function (SSF) subsystem 2004 may send a push or pull network specialization summary to an access point 2006. At 2008, a WTRU 2010 may identify an applicable user profile. At 2012, the WTRU 2010 may scan available networks. At 2014, the WTRU 2010 may probe and receive a response from the access point 2006. At 2016, the WTRU 2010 may send an ANQP query list to the access point 2006, which may respond at 2018 with an ANQP query response that may include the network specialization. At 2020, the WTRU 2010 may collect other specialization summaries from other access networks and may select the best match. At 2022, the WTRU 2010 may attach to the selected access network.

After making use of the metadata information in the content response, the network may leave this information in the response message. The WTRU may receive and store this information, which may make it possible to progressively build a metadata-based profile for the user's interests. This information may be fragmented per user and also according to context. For example, if a WTRU downloads sports-related content during a session, and only children's entertainment in a second session, the two sessions may actually have been conducted by different people. The same person may consume entertainment in one context and work-related documents in another. Context can be determined by time, day of the week, access network, etc. A metadata information element may be a data point in the space of all possible labels (e.g., when it is not summarized), or in the space of all possible values of the summaries. This user profile may be used as follows.

Network selection may generally involve selecting an applicable user profile, rating available networks, and selecting the best rating. Other factors, such as user policy and user decision, may affect the selection as well. A WTRU may reevaluate the user profile on a periodic basis or at specific moments (e.g., when starting a new application). As a result, the WTRU may reselect and attach to a new access network.

Existing clusterization algorithms (e.g., K-means) can be used to dynamically identify clusters of data points in this space. A cluster may contain a set of data points that form the cluster metadata information or profile metadata information, since every cluster can be seen as an independent user profile. The end user can contribute to the clusterisation by indicating who is using the WTRU. The WTRU may identify a likely applicable cluster, e.g., the most likely applicable cluster (e.g., depending on the first request, time of day, selection by the end user, etc.). The cluster metadata information can be rated relative to one or more network specializations advertised by available access networks. The highest rating can be selected by the WTRU.

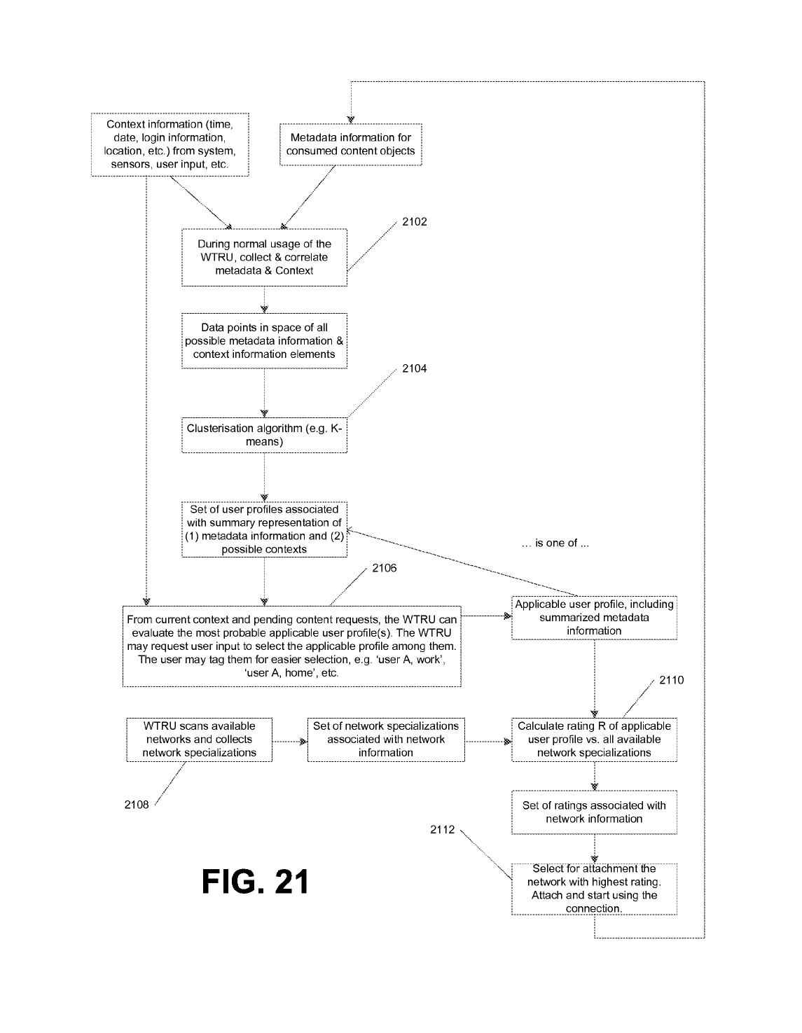

FIG. 21 illustrates an example of user profile generation on a WTRU and selection of an access network based on network specialization. At 2102, metadata and context may be collected and correlated during usage of the WTRU. The information may represent data points in the space of possible metadata information and context information elements. Clusterization, for example, according to a K-means algorithm, may be performed at 2104. This may produce a set of user profiles associated with a summary representation of the metadata information and possible contexts.

At 2106, based on the current context and pending content requests, the WTRU may evaluate the most probable applicable user profile(s). The WTRU may request user input to select the applicable profile among them. The user may tag them for easier selection, e.g., “user A, work,” “user A, home,” and the like.

At 2108, the WTRU may scan available networks and may collect network specializations. At 2110, the WTRU may calculate a rating R of applicable user profiles relative to all available network specializations. At 2112, the WTRU may select for attachment the network with the highest rating. The WTRU may attach to the selected network and may start using the network.

The processes and instrumentalities disclosed herein may be generalized to other layer 2 or 3 discovery mechanisms, including, for example, DHCP, EAP enhanced with discovery mechanisms, and the like.

An application layer mechanism may be used. For example, an application may be running on a WTRU, e.g., in the background. The WTRU may select and attach to a network without using any of the discovery mechanisms disclosed herein. The application may then connect with a content specialization discovery service (e.g., a REST API deployed by a third party on the Internet, or deployed by the access network). The WTRU may query this service for content specialization of the access network, and possibly all other networks available nearby the WTRU. The WTRU may then decide whether another network is more appropriate for the user's profile, by rating other available networks relative to the user profile. This rating and network selection may be performed by the service itself. For example, the WTRU may send its user profile to the service. The service may rate this user profile relative to available networks and may return a list of networks to the WTRU, for example, ordered by rating. The WTRU may select the highest rated network or may also take into account other information such as user policy or user input.

Network selection as disclosed herein can be applied to select an interface for requests related to a specific application or for individual requests within the same application, in a multi-homed device. For example, the WTRU may apply network selection to select more than one network. For example, these networks can be chosen to be complementary with each other regarding their content specialization.

Once the WTRU is attached to two or more networks, the WTRU may select the proper egress interface for the content request, for example, by rating the content metadata with the content specialization of each attached network and selecting the highest match (or the n-highest match). The content metadata may not be known when sending a first content request. The WTRU may estimate or guess it or not take content specialization into account to send this first request. The WTRU may then obtain the content object, with metadata included. The WTRU may obtain metadata from a metadata lookup service. Future requests from the same application or same use may then be guessed more accurately. If the WTRU sends a content object in response to a request from another device, the classification metadata may be determined by the WTRU, which can then accurately select the egress access network based on the best rating.

A network recommendation may be obtained. The WTRU may have a set of user profiles, which may be combined with related metadata information. A user profile may apply to a person in a particular context, reflecting the many interests that one can have, e.g., from cooking to sports, a specific branch of professional knowledge, etc. Profiles may be selected and combined, e.g., a given user logged in the WTRU can be associated with a set of profiles, and the WTRU can determine sub-profiles associated with context information, such as geographic location and time of day. This sub-profile may be subsequently reevaluated based on actual usage during the session. It may be assumed that the WTRU selects the appropriate profile P.

The WTRU may attach to a network best fitting the profile P. The WTRU can now request content recommendations from the network by sending a recommendation request to the SSF, including the combined metadata information for that profile. For example, the combined metadata may list explicit metadata tags and/or may include Bloom Filters summarizing metadata information for this profile. The SSF may rate content cached in the network relative to this combined profile metadata, and may return a list of content object names and metadata to the WTRU, which can then present the list to the user.

This type of recommendation can be useful in cases where the backhaul may have limited capacity, and the network may serve a large number of users, e.g., a stadium's WiFi network. Recommendations can be offered on a per-user basis. Further, cached content may be renewed without active management by the network operator.

The SSF subsystem or the cache may obtain a recommendation, for example, by receiving profile metadata information PM. This may include, for example, a list of schemes, and for each scheme, a list of tags or a summary such as a Bloom Filter. A given scheme may appear more than once. Since merging summaries can lead to higher chance of false positive, the WTRU may avoid merging Bloom Filters beyond a certain fill rate.

For each object in the cache that is popular enough (e.g., request counter>n) and within the specialization of the network (e.g., rating R>0), a rating R2(COM,PM) may be calculated, where COM is the cached object metadata and PM is the profile metadata. For example, R2(COM,PM) may be calculated by starting at a value of 0. The value of R2(COM,PM) may be incremented by a value of A for each match found between any tags of the same scheme found in common between COM and PM. The value of R2(COM,PM) may be incremented by a value of B for each bit in common between Bloom filters for the same scheme between COM and PM. A and B may be set to account for the risk of false positives in Bloom filters and to account for the number k of hash functions used in the Bloom Filters. For example, if k=3, a single tag can result in three bits set to 1 in the BF. For example A=5 and B=1. The C cached content objects with the highest ratings R2(Call, PM) may be selected and returned to the WTRU.

Specialization may be used in inter-network communication. For example, different network domains may exchange their current network specializations for the purpose of facilitating routing of request and/or responses.

User profiles may be pre-generated rather than progressively generated from metadata related to content obtained by the end user. For example, an application may pre-generate such a user profile, e.g., a streaming client may have a pre-built user profile associated with it. If the WTRU attaches an access network (or reevaluates the access network it is using) as a result of the user starting this application, this pre-built user profile may be used to rate candidate access networks. The application service may maintain the user profile based on historical usage data for this user, and may update the pre-built user profile on the WTRU based on this historical data. As another example, the WTRU may hold and/or maintain a number of pre-built user profiles that the user may select when accessing the network.

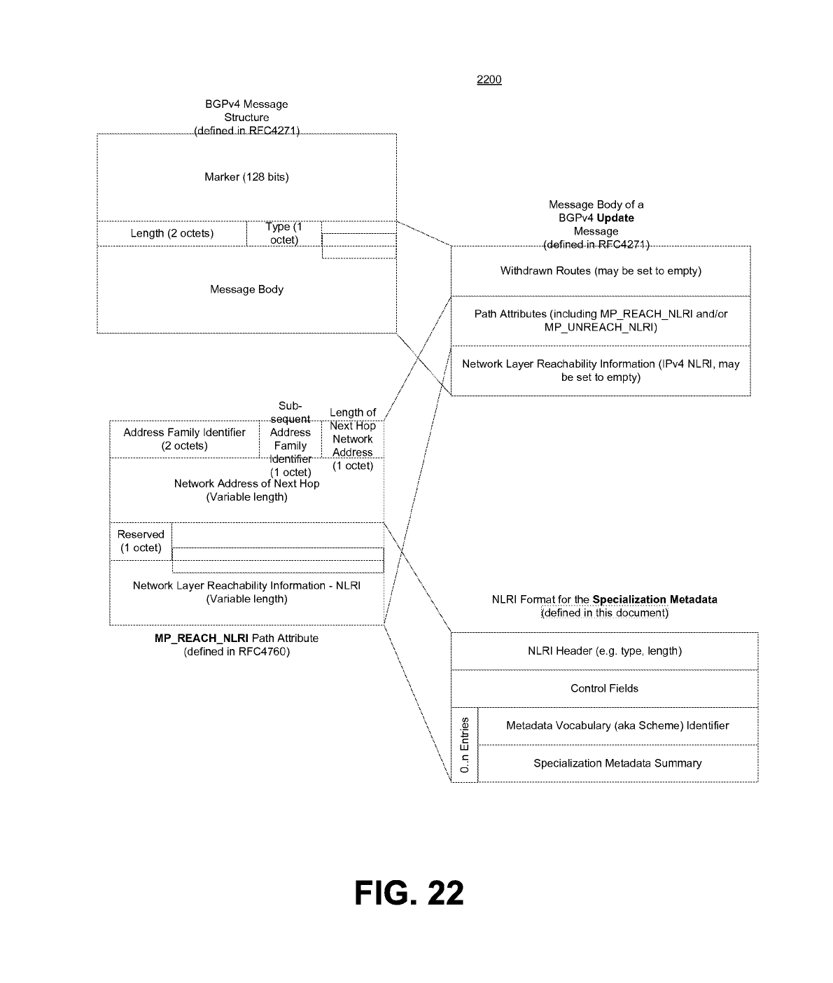

For example, an inter-domain routing protocol extension may be used for content specialization. In the context of ICN (e.g., CCN) networking, BGP may be used for inter-domain routing. BGP may advertise content name prefixes in this context. This ICN-enabled BGP may support advertisement of network specialization to other networks to enable content specialization-based selection of peer or provider networks. FIG. 22 illustrates an example message structure 2200 for inter-domain network specialization communication.

In the exemplary context of CCN, a first CCN network may route traffic toward IP addresses within a sub-domain “sport.nbc.com”. From a metadata lookup service or from nbc.com or from a local cached copy of this metadata, a first IP network may learn that content delivered by this sub-domain may have certain metadata labels (e.g., “Sport,” “Football”). The first CCN network may rate the metadata summary of the sub-domain against each one of its neighbors and selects the network with the best rating, since it is more likely to have this content in cache, or to keep it cached for the next request. At the end of the process, the first CCN network may select the two or three neighbors with the best ratings.

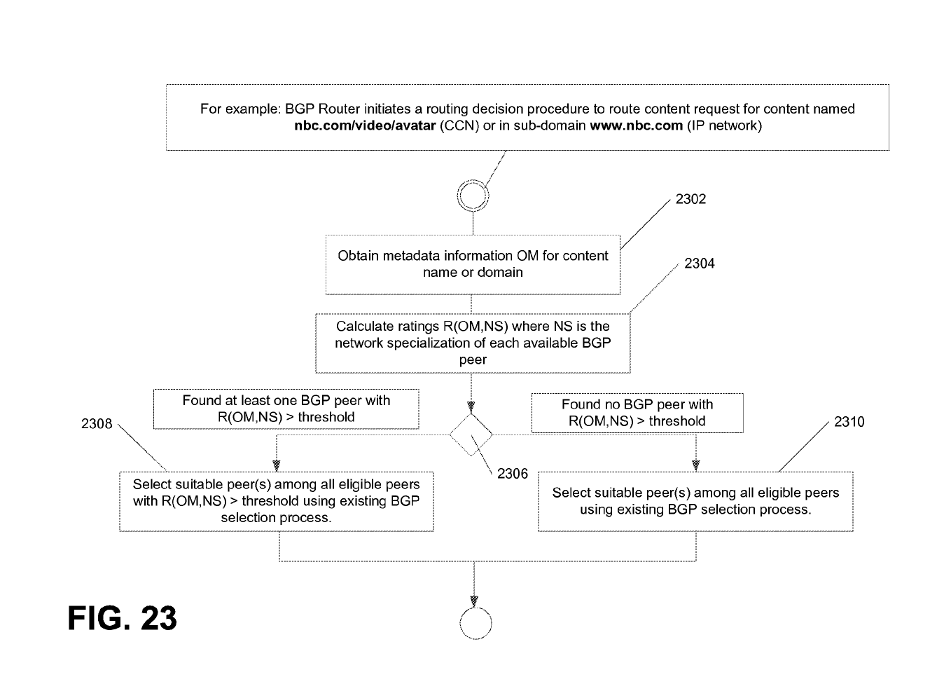

FIG. 23 illustrates an example of network specialization awareness in BGP. Multiple ICN technologies can be covered by the network specialization awareness illustrated in FIG. 23. In the exemplary CCN case, the ICN-enhanced BGP router may receive a content request for a given content name. The BGP router may have knowledge of the network specialization of its peers, for example, using the BGP extension disclosed herein. At 2302, the BGP router may retrieve metadata information for the content object (or a domain or a scope/group holding this object). At 2304, the BGP router may rate the content object metadata relative to the specialization of each peer. If any rating is above a threshold at 2306, the BGP router can proceed with its usual selection process on the subset of peers that are above this threshold at 2308. If a rating is below the threshold at 2306, the BGP router may proceed with the usual selection process at 2310.

Caching storage space can be provided along with specialization information in BGP. For example, a network operator could decide to dedicate a certain amount of storage space to a certain content specialization, and another amount to another content specialization. As part of the selection, a network can prefer a network providing more cache storage over another one similarly specialized.

Chaining of specialization can be taken into account. For example, a first network may be specialized in topic A (caching capacity 100 TB), and may be connected to a second network, which is also specialized in topic A (caching capacity 200 TB). The first network 1 may advertise to a third network that it is specialized in topic A, with a caching capacity of 100 TB+0.5*200 TB=200 TB, where the factor 0.5 is an attenuation factor that takes into account the additional hop to the second network. Caching capacity can be replaced with another measure of specialization, such as a numerical weight.

A CDN Interconnection (CDNI) protocol may be extended to support content specialization, e.g., specialization-based selection of downstream CDNs. In the context of CDNs interconnected using the CDNI protocol, the CDNI protocol may enable CDNs to indicate their specialization to peer CDNs. Later, when processing a content request, an upstream CDN may take this specialization into account to select a proper downstream CDN, for example, by calculating a rating for the content relative to the specialization of potential downstream CDNs. To speed up the process, the upstream CDN may prefetch the content metadata ahead of time, for example, from the publisher or from the metadata service.

Capabilities semantics may include a delivery protocol (e.g., HTTP or RTMP), an acquisition protocol (e.g., for acquiring content from a uCDN), a redirection mode (e.g., DNS redirection or HTTP redirection), capabilities related to CDNI logging (e.g., supported logging mechanisms), and capabilities related to CDNI metadata (e.g., authorization or support for proprietary vendor metadata). A capability entry CDN Specialization may be encoded in JSon as follows, for example:

{

“specializations”: [

{

“vocabulary”: “DDC”,
“summary”: {

type: “csv”,
value: “123,456,6**,890”
}

},
{

“vocabulary”: “DDC”,
“summary”: {

type: “bloom.filter”,
size: “512”,
value:

“MDEyMzQ1Njc4OUFCQ0RFRkdISUpLTE1OT1A=”

}

},
{

“vocabulary”: “Domains”,
“summary”: {

type: “bloom.filter”,
size: “1024”,
value:

“TURFeU16UTFOamM0T1VGQ1EwUkZSa2RJRFMU9UMU
E9”

}

},

]

}

In this example, the value of the first summary may be a comma separated string, and the second summary may be a Base64 encoding of a 512-bit Bloom Filter summarizing a set of tags following the Dewey Decimal Classification. The third entry may summarize a list of domains that are part of the network specialization.

When a CDN receives a CDN specialization, the CDN can configure its request routing function with it. Rating for a particular content object or a particular domain can be precalculated or calculated and cached by the request router.

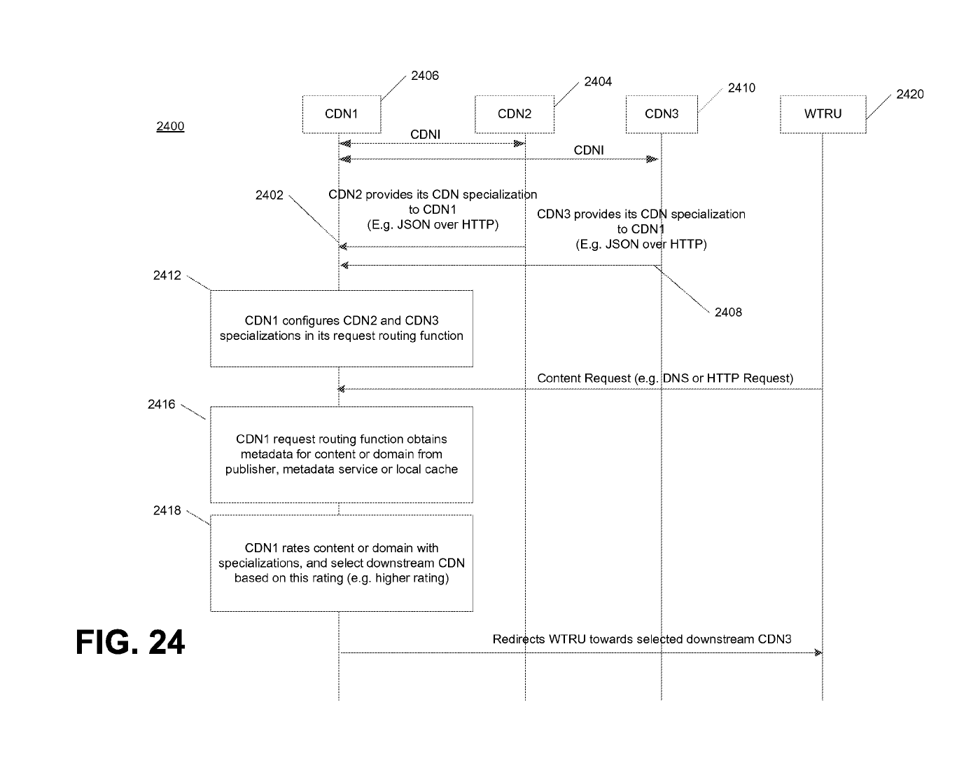

FIG. 24 illustrates an example message flow 2400 that may be used in CDN specialization. At 2402, a CDN 2404 may provide its CDN specialization to a CDN 2406, for example, using JSon over HTTP. At 2408, a CDN 2410 may provide its CDN specialization to the CDN 2406, for example, using JSon over HTTP. At 2412, the CDN 2406 may configure the CDNs 2404 and 2410 specializations in its request routing function. At 2414, the request routing function may obtain metadata for content or domain from a publisher, a metadata service, or a local cache. At 2416, the CDN 2406 may rate content or a domain with specializations, and may select a downstream CDN, e.g., CDN 2410 based on this rating, e.g., a higher rating. At 2418, the CDN 2406 may redirect a WTRU 2420 toward the selected downstream CDN 2410.

JSon encoding of CDN specialization may provide a way for CDNs with overlapping coverage to cooperate as downstream CDNs. For example, if CDNs A, B, and C are covering the same geographical area and the same types of devices, upstream CDNs 1, 2, and 3 may have few criteria to discriminate between them. It may be assumed that each CDN 1, 2, and 3 are interconnected with every CDN among A, B and C. CDNs A, B and C may each have a copy of many different content objects, reducing the overall efficiency of the combination of CDN A, B, and C. One way to avoid this redundancy is to have CDNs 1, 2, and 3 use some form of hashing algorithm to select the downstream CDN for a domain. For example, a portion (e.g., one third) of the possible hash values (domain names) may be attributed to each CDN among A, B and C. CDNs 1, 2, and 3 may coordinate to use the same hash function. This scheme may not work in the case of partial interconnections (e.g., CDN 1 connected to A and B, CDN 2 to B and C, etc.). Content network specialization may offer a way to select downstream CDNs in a predictable manner that may not involve the use of a well-known hash algorithm and that may be resistant to interconnection variations. As a result, in our example, CDNs A, B and C can specialize in complementary ways and may provide a better overall service to CDNs 1, 2, and 3.

Different network domains can exchange their current network specialization for the purpose of better cooperation with each other. For example, networks may check if the behavior of some of their users may better fit another network and, if so, may redirect them towards this network. As another example, networks may negotiate the partitioning of the metadata information space in order to improve (e.g., optimize) their operation. These examples may be complementary and may enable several networks to cooperate to improve (e.g., optimize) their operation and increase end user experience.

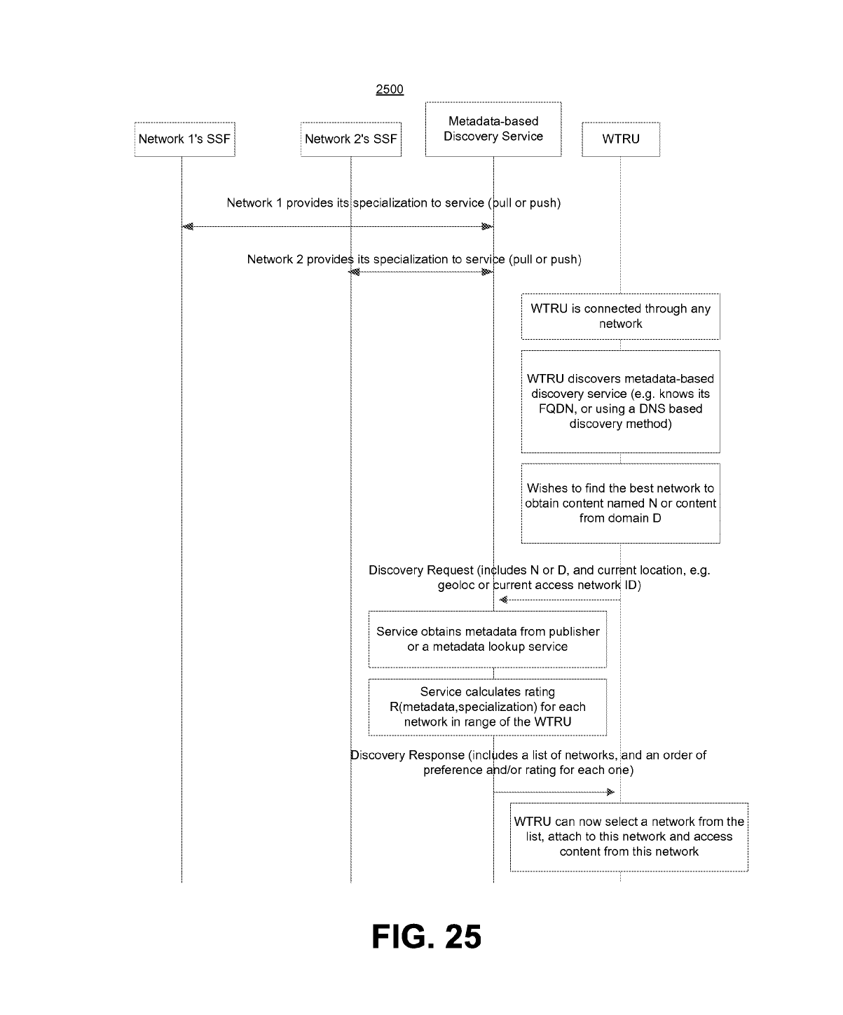

In an example, network specialization may be exchanged for cooperative support for dynamic metadata-based roaming. Overlapping networks may advertise their specialization to each other. A first network can then evaluate (e.g., using the rating function) how well a user profile matches each network. If a user profile rating relative to the first network falls below a threshold and if a second network is found for which the rating is above another threshold, then the WTRU can be redirected towards this second network. This redirection can follow a push and pull message flow 2500 as shown in FIG. 25. The WTRU may decide to discover a more appropriate network, e.g., as in FIG. 25, the WTRU may wish to get a large content object that may not match the current network's specialization. In another example, the WTRU may reevaluate its applicable user profile and may decide to discover a more appropriate network. Alternatively, in a push approach (not shown), a network redirection recommendation message may be sent by the access network's SSF to the WTRU, with a list of access networks prioritized based on ranking relative to the WTRU's current usage profile. Discovery request and response messages may be direct messages between the WTRU and the discovery service, as shown in FIG. 25, or may be passing through the SSF subsystem of the access network currently used by the WTRU.

In another example, several overlapping networks and SCNs may communicate with a service and may send it statistics about metadata of content requested through their network (e.g., number of times each individual metadata tag was found). The service may provide statistics consolidated between overlapping networks back to every individual network. Each network may align (e.g., optimize) its specialization based on this information. The service may perform this alignment (e.g., optimization) internally and may send network specialization recommendations to all networks. Internal alignment (e.g., optimization) may be applicable to cases where the same entity manages the various physical networks and the specialization service, while network-based alignment (e.g., optimization) may be more applicable to cases where several network operators cooperate with each other.

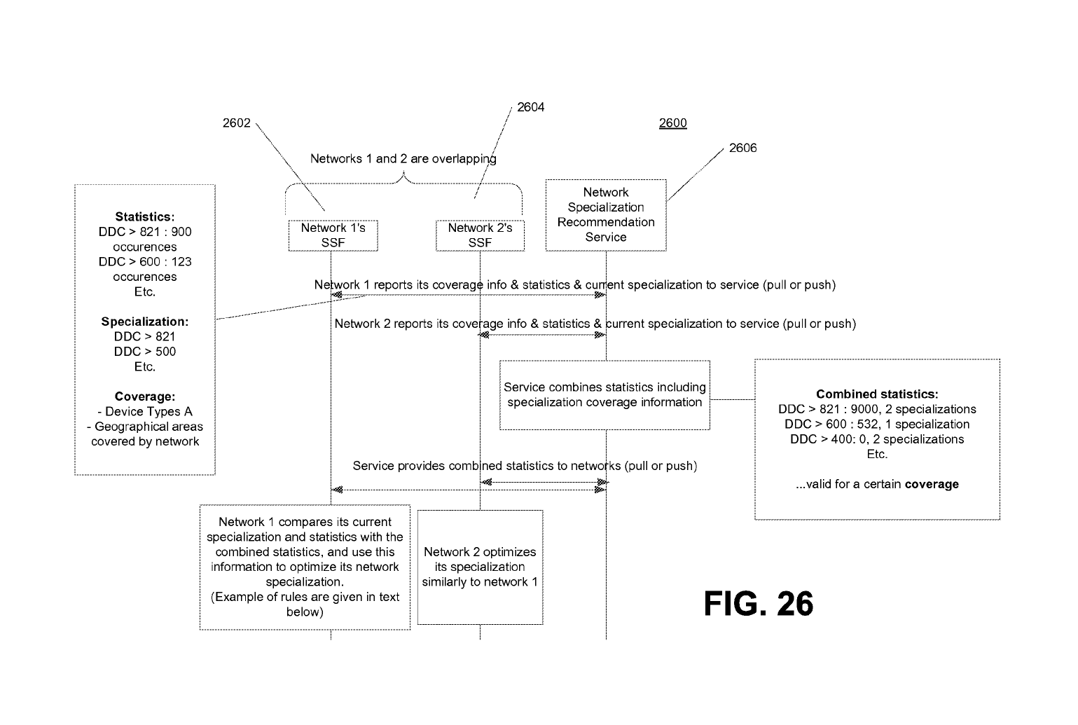

FIG. 26 illustrates an example message flow 2600 for a network specialization service. In the example message flow 2600, multiple networks 2602, 2604 may report statistics (e.g., how many hits for each metadata tag) and their network specialization to a network specialization service 2606. This service 2606 combines this information, and sends back these combined statistics to the networks 2602, 2604. The networks 2602, 2604 may now apply some rules to automatically adjust their network specialization to globally increase the overall network efficiency. This alignment (e.g., optimization) may make sense for overlapping networks. Some alignment (e.g., optimization) may be possible for partially overlapping networks. For example, if network 2602 is smaller than network 2604 and included in the footprint of network 2604, then network 2602 may avoid repeating some of network 2604 specialization, and focus on other topics, while network 2604 may have fewer opportunities to align (e.g., optimize) its specialization. This is why coverage information is included in reports and in the combined statistics.

Some alignment (e.g., optimization) may be performed by networks using their own statistics, e.g., without any such cooperation between networks. Nevertheless, this can result in significant redundancy between topics between networks. Such cooperation between networks may enable reducing this redundancy. Networks may follow rules to align (e.g., optimize) their specialization. For simplicity, the following examples assume that networks are fully overlapping. An example of a high level rule may be that if no network specializes in a topic of interest for a first network's (N1) users and if N1's users are the largest group of users for this topic, the topic may be added to N1's specialization. Another rule may be that if another network specializes in the same topic as N1, and if N1 has fewer users than the other network for this topic, then N1 may drop this part of the specialization.

More complex rules may be added and additional data may be taken into consideration, such as the synergy between topics (e.g., related topics may be in the specialization of a single network) and network operator policy (e.g., a network operator may mandate certain topics that cannot be removed from the specialization of this network). An example of additional consideration could be the access network supported by an end user device. If a network is cellular and another network has more total users in the same specialization but is a different access technology then it might not be wise to drop it.

Specialization may be applied to virtualized networks. An operator may setup several virtual networks over one same physical network, with the intent to differently specialize them. This can help use the network resources according to the needs of the network operator. This may apply to multiple forms of network virtualization, including Virtual Local Area Networks (VLAN), Virtual Private Networks (VPN), and Virtual Private LAN Services (VPLS).

Advantages of virtualization may include enhanced security, limitation to broadcast traffic, dynamic resource allocation based on demand, and differentiated QoS. For example, an ISP may determine ten different network specializations that may be relevant in different contexts (e.g., different time and date for work vs. home usage, and different physical parts of its network). The ISP may create 11 different virtual networks (e.g., 10 specialized networks and 1 non-specialized network). The ISP may allocate certain slices of its network and its caching storage capacity to the different virtual networks. This repartitioning can be changed dynamically to best fit the usage pattern. In this way, most relevant topics will get better QoS and caching capacity than others, using existing tools for managing virtual networks.

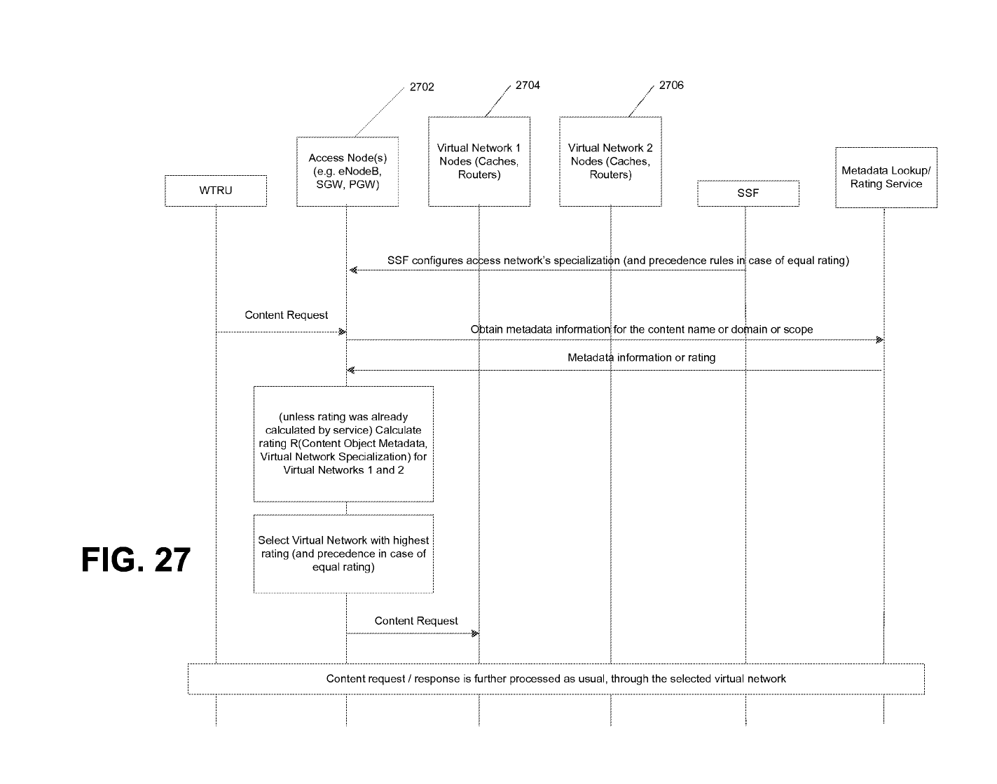

Network specialization features disclosed herein may apply or may be derived to apply to virtualized specialized networks. FIG. 27 illustrates an additional feature in which the access node 2702 may route content requests through different virtual networks 2704, 2706, based on the metadata information associated with the content object.

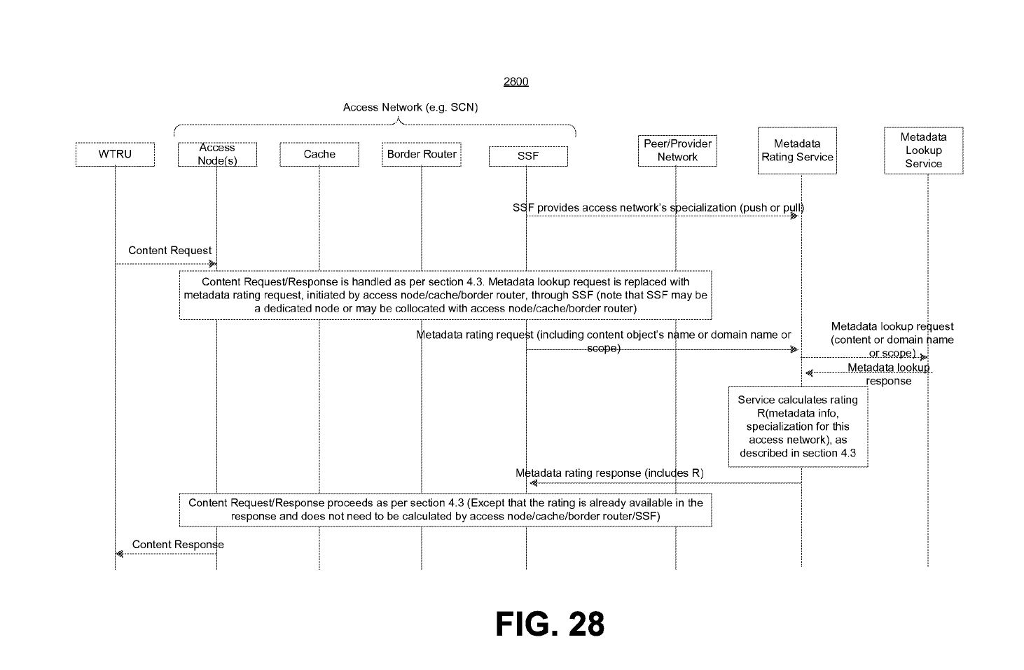

To address privacy issues, the metadata service may be implemented to return a rating, instead of metadata information. The requester may register its network specialization with the service. Upon request for a certain content name, the metadata service may retrieve metadata information for this content object, may calculate the rating and may return it to the requester. FIG. 28 illustrates an example message flow 2800 for a metadata rating service.

In the metadata rating service shown in FIG. 28, the WTRU may not receive the content metadata information back in the response. However, the WTRU may obtain this metadata separately, for example, by querying the metadata lookup service.

There may be a concern for privacy if the classification of a request or a response is made visible to the network provider. The privacy concerned may be addressed by using a metadata rating service. The risk for privacy abuse by the network operator may be significantly reduced, unless there is collusion with the metadata rating service. Another way to address this privacy concern may be to allow the WTRU to set a “no metadata” flag in the content request, which may lead to no metadata being used at any point for the request and response, and a rating of zero. This approach assumes that the network operator can be trusted to honor this flag. Additionally, the publisher may abstain from providing metadata of content, for example, by denying the information to metadata harvesters.

Mutable classification metadata can be produced or changed by a malicious party. This can be addressed with an additional layer for integrity and provenance verification. For example, in the ICN case where metadata is added in a data object header, the header hash value can be signed by the publisher, similarly to how the rest of the data object may be handled for integrity and provenance verification.

The processes and instrumentalities described herein may apply in any combination, may apply to other wireless technology, and for other services.

A WTRU may refer to an identity of the physical device, or to the user's identity such as subscription related identities, e.g., MSISDN, SIP URI, etc. WTRU may refer to application-based identities, e.g., user names that may be used per application.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as CD-ROM disks, and/or digital versatile disks (DVDs). A processor in association with software may be used to implement a radio frequency transceiver for use in a WTRU, UE, terminal, base station, RNC, and/or any host computer.

What is claimed:

1. A caching method, comprising:
configuring a node in a network with a network content specialization;
receiving a request for content; and
if the content is not locally stored:
forwarding the request for content;
receiving a response comprising the requested content and associated metadata about the requested content; and
deciding, based upon the associated metadata and the network content specialization, whether to cache the content.

2. The method of claim 1, wherein if the content is locally stored, sending a content response comprising a cached requested content.

3. The method of claim 1, further comprising rating the associated metadata in relation to the network content specialization.

4. The method of claim 3, further comprising using the rating to make a decision of how long to cache the content.

5. The method of claim 3, further comprising using the rating to determine what level of quality of service (QoS) to treat the content with.

6. The method of claim 3, further comprising using the rating to determine whether to provide content to a wireless transmit/receive unit (WTRU).

7. The method of claim 3, further comprising using the rating to determine whether to communicate with another network to guide routing decisions.

8. The method of claim 3, further comprising using the rating to determine whether to cooperate with another network to improve network specialization.

9. The method of claim 3, further comprising using the rating to determine whether to redirect a WTRU to another network.

10. The method of claim 3, further comprising using the rating to determine whether to advertise a network preference to guide a WTRU's network access selection.

11. A small cell network node, comprising:
a processor configured to at least:
configure the node with a network content specialization;
receive a request for content; and
if the content is not locally stored:
forward the request for content;
receive a response comprising the requested content and associated metadata about the requested content;
rate the associated metadata in relation to the network content specialization; and
decide, based upon the rating, whether to cache the content.

12. The small cell network node of claim 11, wherein the rating is used to determine how long to cache the content.

13. The small cell network node of claim 11, wherein the rating is used to determine what level of quality of service (QoS) to treat the content with.

14. The small cell network node of claim 11, wherein the rating is used to determine whether to provide content to a wireless transmit/receive unit (WTRU).

15. The small cell network node of claim 11, wherein the rating is used to determine whether to communicate with another network to guide routing decisions.

16. The small cell network node of claim 11, wherein the rating is used to determine whether to cooperate with another network to improve network specialization.

17. The small cell network node of claim 11, wherein the rating is used to determine whether to redirect a WTRU to another network.

18. The small cell network node of claim 11, wherein the rating is used to determine whether to advertise a network preference to guide a WTRU's network access selection.

19. The small cell network of claim 11, wherein the node receives the metadata from a metadata lookup source.

20. The small cell network of claim 11, wherein the node receives the metadata from a trusted peer network.
